(19) United States
(12) Patent Application Publication
(10) Pub. No.: US 2006/0158711 A1
(43) Pub. Date: Jul. 20, 2006

(54) Image forming device and image forming method

(76) Inventors: Shigeaki Imai, Kanagawa (JP); Tomohiro Nakajima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/312,692

(22) Filed: Dec. 21, 2005

(30) Foreign Application Priority Data
Dec. 22, 2004 (JP) 2004-372233

(51) Int. Cl. G02B 26/08

(52) U.S. Cl. 359/204

(57) ABSTRACT

An image forming device is disclosed that is able to correct an image distortion even when the installation environment changes or unexpected shocks occur and even when an optical scanning device is exchanged. The image forming device comprises a light source, an optical scanning unit, a development unit, a transfer unit, a test image output unit to output a test image able to determine unevenness of intervals of positions of beam spots formed on an image supporting member, a beam spot position correction unit to correct the unevenness of the beam spot position intervals, and a correction data input unit to select correction data of the unevenness of the beam spot position intervals.

### BACKGROUND OF THE INVENTION

1. Field of the Invention

The present invention relates to a technique of correcting image distortion in a digital copier, a laser printer, a laser facsimile, or others, and in particular, relates to a technique of correcting position or color shift in an image forming device.

2. Description of the Related Art

Generally, in an optical scanning device, which is well-known as being relevant to a laser printer, a laser beam from a light source is deflected by an optical deflector, condensed by a scanning-imaging optical system, such as a fθ lens, toward a surface to be scanned (below, referred to as a “scanning surface”), forming a light spot on the scanning surface. The light spot is moved on the scanning surface to perform optical scanning (main scanning). The scanning surface is the photosensitive surface of a photoconductor, which is photoconductive and serves as a photosensitive medium.

Generally, the optical deflector may be a polygon scanner which has deflection surfaces rotating at a constant speed, or a galvanometric mirror which has vibrating deflection surfaces, or the like. When the above optical deflector is used to form an optical scanning device, with the light source, such as a semiconductor laser, being modulated at a constant frequency, to scan the scanning surface of the photoconductor, positions of the beam spots cannot be arranged to have regular intervals, and the scanning speed is not constant. In order to arrange the positions of the beam spots to have regular intervals and to perform optical scanning at a constant scanning speed, the scanning-imaging optical system, such as the fθ lens, is used to correct the scanning speed, and this enables constant speed scanning on the scanning surface.

However, scanning speed correction with the fθ lens has its limit; it cannot attains accurate regular intervals of the positions of the beam spots on the scanning surface. In other words, there exists unevenness of the intervals of beam spot positions. When the unevenness of the intervals of beam spot positions is present, image distortion occurs, resulting in degradation of image quality. Further, in a color image forming device, a number of fθ lenses are used, and because of uncertainties produced in fabrication and installation of the fθ lenses, the difference of the scanning speed changes depending on colors, and as a result, color shift occurs.

In order to correct the unevenness of the beam spot position intervals, there is a method in which principally the frequency of a pixel clock is modified to correct the beam spot position along the scanning line. For example, reference can be made to Japanese Laid-Open Patent Application No. 11-167081 and Japanese Laid-Open Patent Application No. 2001-228415. There is another method of correcting the unevenness of the beam spot position intervals, in which the phase of the pixel clock is modified to correct beam spot position shifts in a main scanning. For example, reference can be made to Japanese Laid-Open Patent Application No. 2003-98465, and Japanese Laid-Open Patent Application No. 2004-985-90.

Using these methods to correct the beam spot positions and to form images, the unevenness of the beam spot position intervals is reduced, and color images with few color shifts are obtainable.

However, even when color shift correction is performed before shipment in factories by correcting the unevenness of the beam spot position intervals, color shift may still occur because of changes of the installation environment or unexpected shock. In addition, when exchanging the optical scanning device, it is necessary to perform a correction of the unevenness of the beam spot position intervals different from that before exchanging. However, the method of determining the correction data has not been reported yet.

### SUMMARY OF THE INVENTION

Accordingly, it is a general object of the present invention to solve one or more problems of the related art.

A specific object of the present invention is to provide an image forming device able to correct an image distortion even when installation environment changes or unexpected shocks occur.

Another specific object of the present invention is to provide an image forming device able to correct an image distortion even when an optical scanning device is exchanged.

According to a first aspect of the present invention, there is provided an image forming device, comprising: a light source; an optical scanning unit configured to scan a light beam from the light source on an image supporting member to form an electrostatic latent image thereon, said optical scanning unit being exchangeable; a development unit configured to develop the electrostatic latent image with toner to form a visible image; a transfer unit configured to transfer the visible image to a medium; a test image output unit configured to output a test image able to determine unevenness of intervals of positions of beam spots formed on the image supporting member; a beam spot position correction unit configured to correct the unevenness of the beam spot position intervals; and a correction data input unit configured to select correction data of the unevenness of the beam spot position intervals.

As an embodiment, the image forming device further comprises a plurality of position shift detection units that are arranged along a main scanning direction to detect shifts of beam spot positions, wherein the unevenness of the beam spot position intervals is corrected based on detection results of the position shift detection units.

As an embodiment, the test image includes a test pattern for measuring a position shift at least in the main scanning direction of the beam spot.

As an embodiment, the test pattern has a shape enabling measurement of position shifts in both the main scanning direction and a sub scanning direction.

As an embodiment, the image forming device further comprises an insertion unit configured to insert a blank line in front of the first line of image data of an ordinary image; a deletion unit configured to delete the blank line; and an addition unit configured to add a blank line, wherein an image forming position in the sub scanning direction is changed each time by one scanning line by using the insertion unit, the deletion unit, and the addition unit.

As an embodiment, the image forming device further comprises a counting unit configured to count a write starting signal in the main scanning direction, wherein an image forming position in the sub scanning direction is changed each time by one scanning line by reducing the count from the counting unit.

As an embodiment, the image forming device further comprises a deflection unit configured to deflect a light beam in the sub scanning direction, wherein an image forming position in the sub scanning direction is changed by using the deflection unit.

As an embodiment, the deflection unit is a turnable prism.

As an embodiment, the deflection unit is a liquid crystal element able to deflect the light beam electronically.

As an embodiment, measurement positions of the position shift of the beam spot are selectable.

As an embodiment, the beam spot position correction unit performs beam spot position correction by shifting a phase of a pixel clock signal.

As an embodiment, the beam spot position correction unit divides a scanning region into a plurality of sections, and performs the beam spot position correction in each of the sections.

As an embodiment, the position shift detection units are provided near boundary positions between the sections, and the position shift of the beam spot is corrected based on the detection results of the position shift detection units.

As an embodiment, assuming a distance between two of the position shift detection units at outermost positions is a mm, and an interval between two test images is b mm in the sub scanning direction, a and b satisfy the following formula:
0.6≦a/b≦1

As an embodiment, a position of measuring the position shift based on image information is arranged on an inner side of one of the position shift detection units at the outermost position; and the position of measuring the position shift and positions of the position shift detection units are arranged so that the following formula is satisfied:
L max/L min<3

where L max represents the largest one of widths L of sections separated by positions of the position shift detection units, and L min represents the smallest one of the widths L of the sections.

As an embodiment, the image forming device is a multi-color image forming device; and the position shift detection units are color-shift detection units.

As an embodiment, the test image includes a plurality of unit patterns each having a first pattern of a reference color and a second pattern of a color of a measurement object, and one of the first pattern and the second pattern is arranged on two sides of another one of the first pattern and the second pattern in the main scanning direction.

As an embodiment, the test image includes a plurality of lines of patterns; each of the pattern lines includes a plurality of first patterns each of a reference color and a plurality of second patterns each of a color of a measurement object, a number of said first patterns being equal to a number of said second patterns, said first patterns and said second patterns being arranged in the main scanning direction; in each of the pattern lines, intervals between the first patterns are equal to the intervals between the second patterns; and in different pattern lines, positions of the second patterns relative to the first patterns change stepwise in the main scanning direction.

As an embodiment, when setting the relative positions of the second patterns relative to the first patterns to change stepwise in the main scanning direction, an optical scanning starting position of a color to be corrected is set to change stepwise.

As an embodiment, when setting the relative positions of the second patterns relative to the first patterns to change stepwise in the main scanning direction, a number of pixels on a scanning starting side relative to a position of measuring the position shift is increased or decreased, or correction data of the beam spot positions is increased or decreased.

As an embodiment, the test image includes three or more lines of patterns each including a plurality of the first patterns arranged in the main scanning direction, and three or more lines of patterns each including a plurality of the second patterns arranged in the main scanning direction, said second patterns being arranged to be at substantially the same positions as said first patterns; the lines of the first patterns are arranged to be at first predetermined intervals in the sub scanning direction; the lines of the second patterns are arranged to be at second predetermined intervals in the sub scanning direction; a number of the lines of the first patterns is the same as a number of the lines of the second patterns.

As an embodiment, a line of patterns near a center of the three or more lines of the first patterns is at a position the same as a line of patterns near a center of the three or more lines of the second patterns in the sub scanning direction; intervals between the three or more lines of the first patterns and intervals between the three or more lines of the second patterns are different by a value equaling a width of one line in the sub scanning direction.

According to a second aspect of the present invention, there is provided an image forming method used by an image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals, said method comprising a step of: obtaining the correction data from the test image and inputting the correction data by the correction data input unit.

According to a third aspect of the present invention, there is provided an image forming method used by a multi-color image forming device, said multi-color image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, a correction data input unit configured to select correction data of the unevenness of the beam spot position intervals, and a plurality of color shift detection units that are arranged along a main scanning direction to detect color shifts, said method comprising a step of: outputting, after the color shift is corrected based on detection results of the color shift detection units, the test image to correct a color shift between two of the color shift detection units and a color shift at a position outside two ends of the color shift detection units.

According to a fourth aspect of the present invention, there is provided an image forming method used by an image forming device, said image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals, said method comprising a step of: inputting the correction data at least when exchanging the optical scanning unit.

According to a fifth aspect of the present invention, there is provided an image forming method used by an image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals, said method comprising a step of: preparing respective correction data for different optical scanning units to correct the unevenness of the beam spot position intervals of main scanning associated with optical scanning properties of respective optical scanning units, and inputting the correction data when exchanging the optical scanning unit.

As an embodiment, detecting, while inputting the correction data at least when exchanging the optical scanning unit, position shifts by a plurality of the position shift detection units to correct the position shifts.

According to a sixth aspect of the present invention, there is provided an image forming method used by an image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals, said method comprising a step of: outputting the test image to a medium in which a reference of an absolute position in the main scanning direction is recorded.

According to the present invention, it is possible to satisfactorily correct a position shift even when installation environment changes or unexpected shocks occur.

In addition, it is possible to simplify the method of calculating correction values of the beam spot positions, and reliably correct the detected position shifts.

These and other objects, features, and advantages of the present invention will become more apparent from the following detailed description of preferred embodiments given with reference to the accompanying drawings.

### BRIEF DESCRIPTION OF THE DRAWINGS

FIG. 1 is schematic view illustrating a structure of an image forming device according to an embodiment of the present invention;

FIG. 2 is a view of a pattern used in measurement of the color shift;

FIG. 3A through FIG. 3E are a timing chart for explaining a method of correcting an image write position in the sub scanning direction;

FIG. 4A through FIG. 4C are schematic views of the output images for explaining the method of correcting the image write position in the sub scanning direction;

FIG. 5 is a view of a deflection unit for schematically illustrating a method of optically shifting the image write position in the sub scanning direction;

FIG. 6A and FIG. 6B are views of a liquid crystal element for schematically illustrating a method of shifting the image write position in the sub scanning direction;

FIG. 7 illustrates details of the effective area A of the liquid crystal material 43 as viewed from the incidence side;

FIG. 8A through FIG. 8C illustrate the effects when a voltage is applied on the liquid crystal material 43;

FIG. 9A through FIG. 9C are diagrams for explaining the principle of correcting beam spot position shifts in one section;

FIG. 10 shows an example of dividing one line into plural sections;

FIG. 11 is a block diagram illustrating a circuit for generating a pixel clock signal;

FIG. 12A through FIG. 12C are timing charts illustrating operations of the circuits shown in FIG. 11, for explaining the principle of changing the period of the pixel clock based on the phase data indicating the transition timing of the pixel clock;

FIG. 13 is a timing chart for explaining another example of assigning the phase data;

FIG. 14A through FIG. 14C are diagrams exemplifying phase shift of the pixel clock signal PCLK two pixels by two pixels;

FIG. 15A and FIG. 15B explain the method of changing the frequency of the pixel clock signal PCLK in each section;

FIG. 16 is a schematic view exemplifying the detection pattern of the toner images;

FIG. 17 is a graph showing measurement data of resist shift, where the abscissa represents a ratio of a detection interval a to a main scanning width b;

FIG. 18A and FIG. 18B are diagrams exemplifying positions of color shift detection based on image information and positions of the color shift detection units;

FIG. 19 is a graph showing measurement data under different arrangements;

FIG. 20A through FIG. 20D are diagrams illustrating patterns suitable for detecting the color shift by using the output images;

FIG. 21 is a diagram illustrating an example of output of a pattern for detecting the color shifts in the main scanning direction;

FIG. 22 is a diagram illustrating a method of shifting the detection pattern in the sub scanning direction;

FIG. 23 is a diagram illustrating a method of shifting the detection pattern in the sub scanning direction;

FIG. 24 is a diagram illustrating an example of output of a pattern for detecting the color shifts in the sub scanning direction;

FIG. 25 is a diagram illustrating an example of output of a pattern for detecting the color shifts in the sub scanning direction; and

FIG. 26A and FIG. 26B are diagrams illustrating examples of media on which predetermined patterns are printed in advance.

### DESCRIPTION OF THE PREFERRED EMBODIMENTS

Below, preferred embodiments of the present invention are explained with reference to the accompanying drawings.

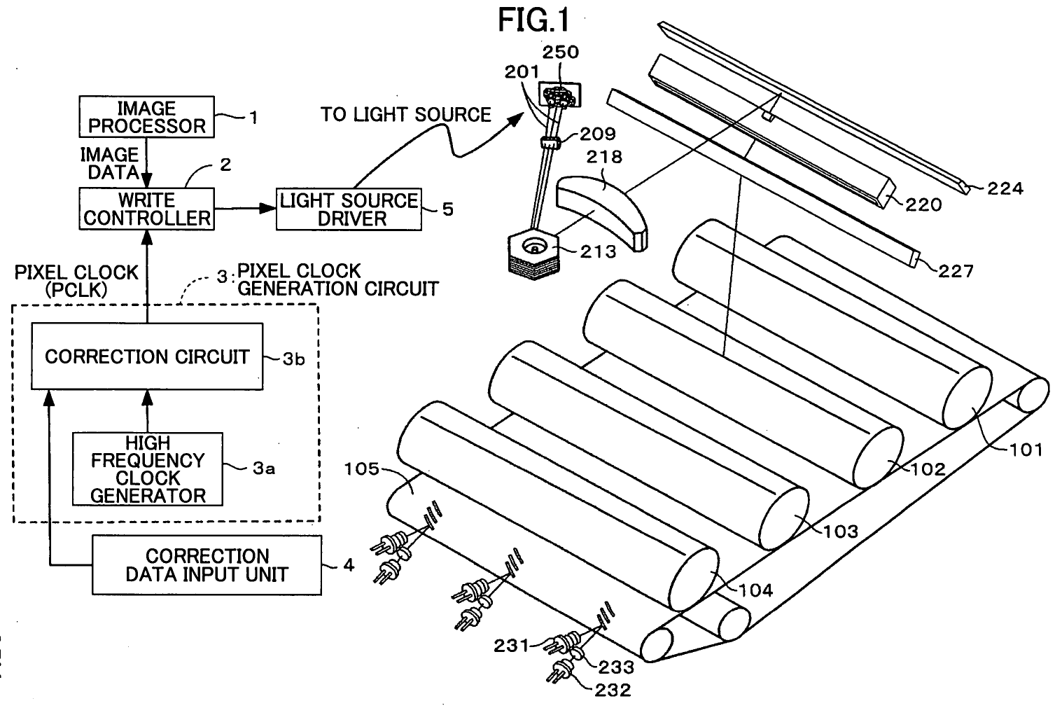

FIG. 1 is schematic view illustrating a structure of an image forming device according to an embodiment of the present invention.

The image forming device shown in FIG. 1 includes an image processor 1, a write controller 2, a pixel clock generation circuit 3, a high frequency clock generator 3a, a correction circuit 3b for correcting unevenness of beam spot position intervals, a correction data input unit 4 for inputting correction data of beam spot positions, a light source driver 5, a beam spot position correction unit 10, photoconductors 101 to 104, a transfer belt 105, a cylindrical lens 209 for correcting an optical face angle error, a polygonal mirror 213, a fθ lens 218 as a first condensing lens, a toroidal lens 220 as a second condensing lens, mirrors 224, 227, a projection element 231, a light receiving element 232, a light receiving lens 233, and light source units 250 (only one light source unit 250 is illustrated in FIG. 1).

FIG. 1 shows optical scanning units installed in a full color image forming device, which include four stations scanning in the same direction. For sake of simplicity, only one station is illustrated in detail in FIG. 1.

In the color image forming device in FIG. 1, four photoconductors 101, 102, 103, and 104 are arranged along the moving direction of the transfer belt 105 to transfer toner images of different colors sequentially, thereby forming a color image. The optical scanning units are formed integrally to scan all the light beams 201 on the same surface of the polygonal mirror 213.

A pair of semiconductor lasers are provided corresponding to each of the photoconductors 101, 102, 103, and 104 to scan adjacent lines in the sub scanning direction according to the recording density, in other words, every two lines are scanned each time. The light source units 250 are arranged so that emitting positions of the light beams 201 from different light source units 250 are at different positions in the sub scanning direction, or the emitting directions of the light beams 201 from different light source units 250 are in a radial pattern toward a deflection point of the polygonal mirror in the main scanning direction. In addition, light paths of the light beams 201 from light emission points to the deflection point of the polygonal mirror are set to be equal.

The cylindrical lens 209 has a flat surface on one side and a curved surface on the other side of a curvature common in the sub scanning direction. The cylindrical lens 209 is combined with the toroidal lens 220 as described below to form an optical system for correcting the optical face tangle error so that all the light beams 201 are focused to be lines in the sub scanning direction on the deflection surface, and the deflection point and the surface of the photoconductor are conjugate with each other in the sub scanning direction.

All the light beams 201 are emitted from the semiconductor lasers to be parallel to the sub scanning direction and be at regular intervals, for example, the regular intervals L being equal to 5 mm. These intervals are still preserved on the reflection surface of the polygonal mirror, allowing the light beams 201 to be incident on the reflection surface perpendicularly.

Thus, it is physically difficult to overlap light units each holding a semiconductor laser and a coupling lens in the sub scanning direction (vertical direction); hence, the light units are arranged to be shifted from each other in the main scanning direction.

The polygonal mirror 213 is formed to be relatively thick. For example, in the present embodiment, in order to reduce windage loss, grooves are formed on the six mirrors of the polygonal mirror 213 at portions not used for deflection, that is, portions of the mirrors between two light beams, so that the distances from the center of the polygon to these portions are slightly smaller than the radius of the inscribed circle of the polygon, and the thickness of one layer is 2 mm.

The fθ lens 218, which is commonly used by all the light beams 201, is formed to be relatively thick, and does not possess focusing capability in the sub scanning direction. In the main scanning direction, the fθ lens 218 has a non-arc surface of focusing capability so that the light beams are moved on the surface of the photoconductors 101, 102, 103, 104 at a constant speed along with rotation of the polygonal mirror 213. In addition, the fθ lens 218, together with the toroidal lens 220, one of which is provided for each light beam and has the function of correcting the optical face angle error of the polygonal mirror 213, forms optical scanning units that form beam spots of the respective light beams 201 on the surfaces of the photoconductors 101, 102, 103, 104, and record four latent images at the same time.

In each of the optical scanning units, a number of mirrors 224, 227 are provided to equalize the light paths from the polygonal mirror 213 to the surface of the photoconductors 101, 102, 103, 104, and to equalize the incident positions and incident angles on the photoconductor drums 101, 102, 103, 104, which are arranged at regular intervals.

Below, the light path in each optical scanning unit is explained. A light beam 201 from the light source unit 250 is deflected by the polygonal mirror 213, and passes through the fθ lens 218; then, the light beam 201 is reflected by the mirror 224 and enters into the toroidal lens 220; then the light beam 201 is further reflected by the mirror 227, and then is directed to the photoconductor 102, for example, to form a yellow image. The above optical system serves as a first scanning unit.

In the present embodiment, the beam spot position correction unit 10 is provided to correct the unevenness of the beam spot position intervals.

Because of the beam spot position correction unit 10, the unevenness of the beam spot position intervals can be corrected, and thus it is possible to provide color images with very few color shifts.

As described above, even when color shift correction is performed before shipment in factories by correcting the unevenness of the beam spot position intervals, color shift may still occur because of changes of the installation environment or unexpected shock; as a result, color images with noticeable color shifts may be output. To solve this problem, in the present invention, a correction data input unit is provided to input or select correction data of the unevenness of the beam spot position intervals. Depending on information of output images, a user or a service person may use the correction data input unit to correct the color shift.

Below, a method is described for obtaining correction data of the beam spot positions.

Considering the method of measuring the color shift in the information of output images, for a multi-function printer (MFP) having a scanner function, the color shift can be measured by using the scanner. For a multi-function printer (MFP) not having the scanner function, the color shift may be measured by human eyes.

When measuring the color shift by eye, it is preferable that the correction data input unit be able to input or select the direction of the color shift (that is, to what color the color under consideration is shifting) and the correction data in a stepwise manner. For example, preferably, the correction data can be selected at intervals of 50 μm.

In doing so, it is possible to correct the color shift to be un-recognizable by people's eyes, and input of the correction data is very simple.

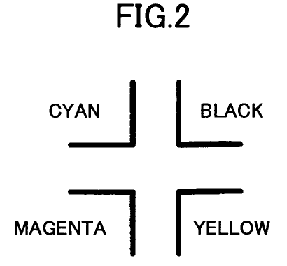

FIG. 2 is a view of a pattern used in measurement of the color shift.

The image information to be output may be characters, images, or any other things. It is preferable that the image information allow measurement of the color shift at least in the main scanning direction. By using the color shift measurement pattern, it is possible to detect the color shift easily at high precision, and hence, it is possible to realize high precision color shift correction.

Preferably, as shown in FIG. 2, the color shift measurement pattern is in an L-shape, and this enables color shift measurement in both the main scanning direction and the sub scanning direction. With such a pattern, color shifts in both the main scanning direction and the sub scanning direction can be measured. The pattern shown in FIG. 2 is referred to as “a unit pattern”, meaning that this pattern is a unit of various color shift measurement patterns.

In correspondence to one or more positions where color shift measurement is to be made, the unit pattern is arranged to be aligned with the same sub scanning line as those color shift measurement positions.

It should be noted that the pattern shown in FIG. 2 is just an example, and the color shift measurement pattern of the present invention is not limited to the pattern shown in FIG. 2. For example, the order of colors may be changed, and the lines in the pattern in FIG. 2 may be straight lines or inclined lines, or circles; or the L-shape may be rotated.

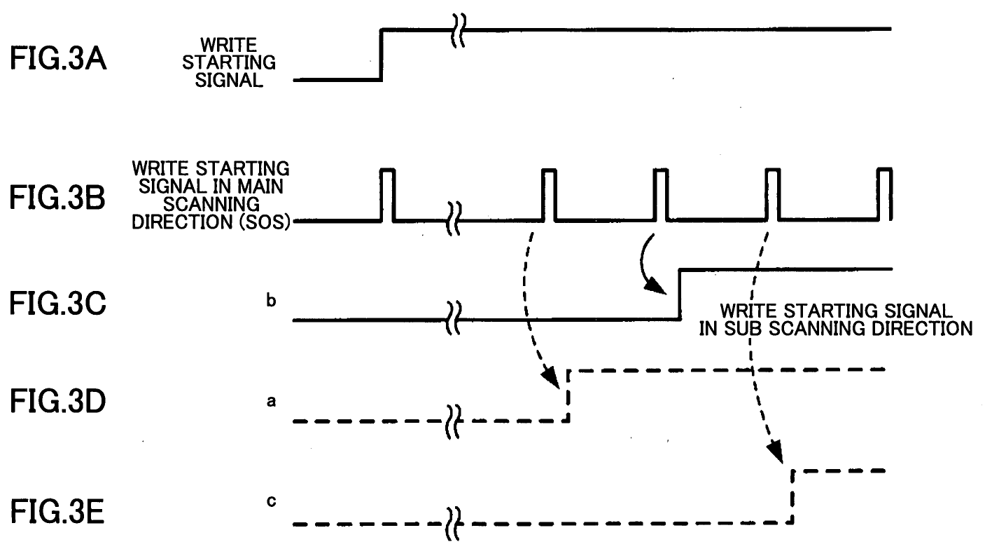

FIG. 3A through FIG. 3E are a timing chart for explaining a method of correcting an image write position in the sub scanning direction.

While the color shift in the main scanning direction occurs along with the unevenness of beam spot position intervals in the main scanning direction, the color shift in the sub scanning direction has little dependence on the unevenness of beam spot position intervals. In most cases, the color shift in the sub scanning direction is originated from shifts of the image write positions of different colors in the sub scanning direction. Therefore, in order to correct the color shift in the sub scanning direction, it is sufficient to correct the image write positions in the sub scanning direction.

As a preferable method of adjusting the image write positions in the sub scanning direction, the timing of a write starting signal in the main scanning direction (denoted as “SOS”) may be counted with a sensor, and the image write positions in the sub scanning direction can be adjusted by increasing or decreasing the count. FIG. 3A through FIG. 3E show adjustment of the image write position in the sub scanning direction.

In addition, there are also other methods of adjusting the image write positions in the sub scanning direction.

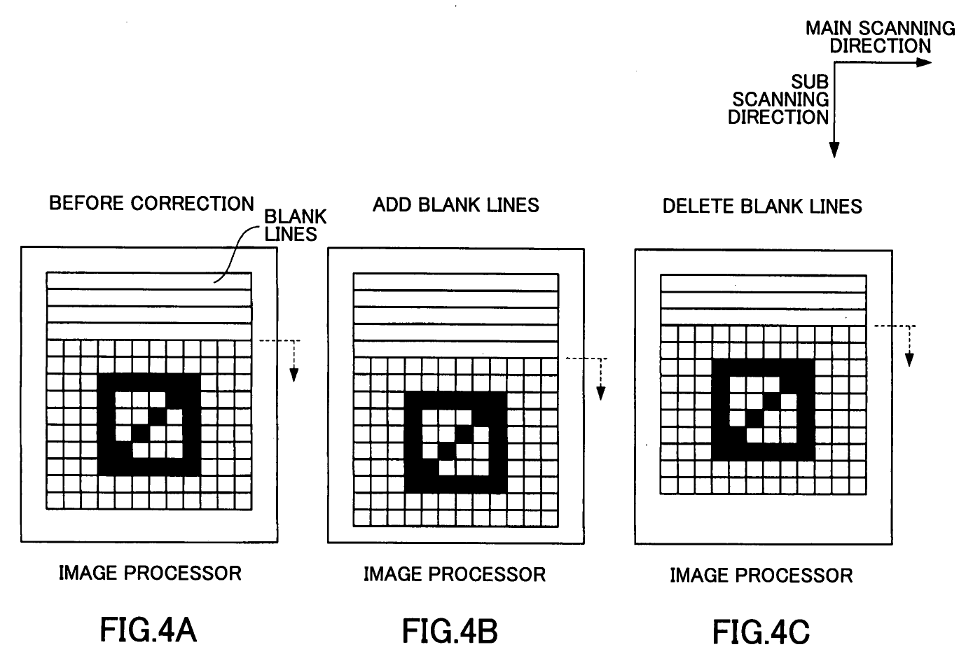

FIG. 4A through FIG. 4C are schematic views of the output images for explaining the method of correcting the image write position in the sub scanning direction.

As shown in FIG. 4A through 4C, image data may be re-arranged to allow one or more blank lines to be inserted beforehand prior to the first line of the original image data, and when necessary, the blank lines may be deleted, or new blank lines may be inserted. In doing so, the image write positions in the sub scanning direction can also be adjusted.

With the above methods, it is possible to adjust the image write positions in the sub scanning direction each time by one scanning line (or one pixel in the sub scanning direction), and to correct the color shift in the sub scanning direction.

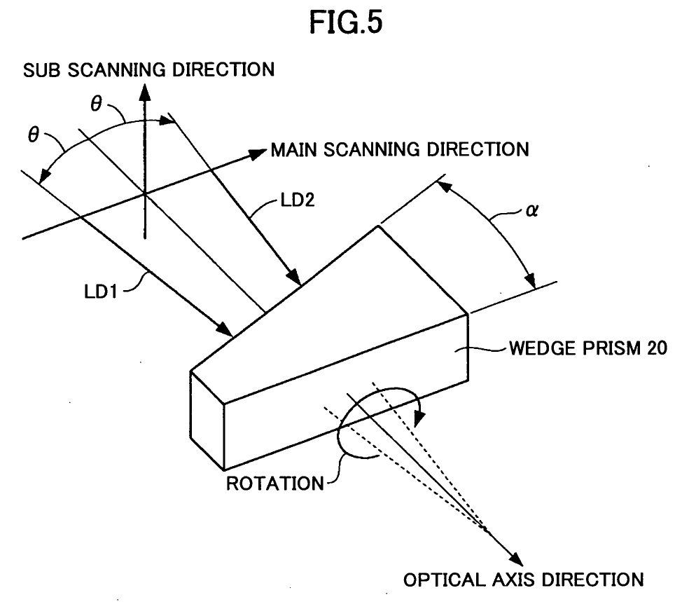

FIG. 5 is a view of a deflection unit for schematically illustrating a method of optically shifting the image write position in the sub scanning direction.

In the methods shown in FIG. 3A through FIG. 3E and FIG. 4A through FIG. 4C, the image write positions in the sub scanning direction can only be adjusted each time by one scanning line. In order to adjust the image write positions in the sub scanning direction less than one scanning line, a deflection unit may be used to deflect the light beam in the sub scanning direction.

FIG. 5 shows an example of such a deflection unit. The deflection unit shown in FIG. 5 is a wedge prism 20, that is to say, the incidence plane and the exit plane are inclined relative to each other. If this wedge prism is provided between the light source unit 250 and the cylindrical lens 209, by rotating the wedge prism with the optical axis being a rotational axis, the light beam can be deflected in the sub scanning direction, and the image write positions in the sub scanning direction can be adjusted less than one scanning line.

The above effects can also be attained by using materials exhibiting an electro-optical effect, such as liquid crystal materials, or LiNbO₃.

Below, an example is presented using materials exhibiting the electro-optical effect.

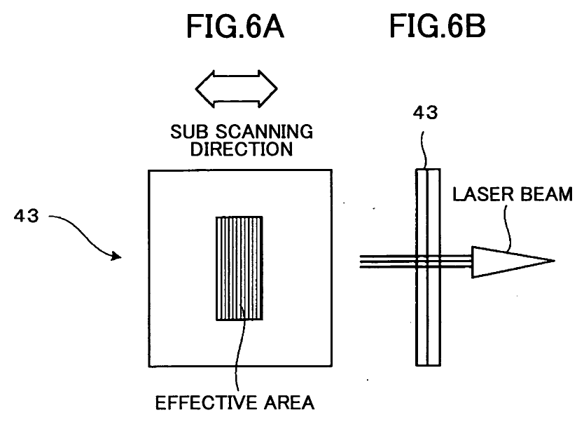

FIG. 6A and FIG. 6B are views of a liquid crystal element for schematically illustrating a method of shifting the image write position in the sub scanning direction, where FIG. 6A is a front view and FIG. 6B is a side view of the liquid crystal element.

In FIG. 6A and FIG. 6B, reference number 43 represents a liquid crystal material, and a sign A represents an effective area.

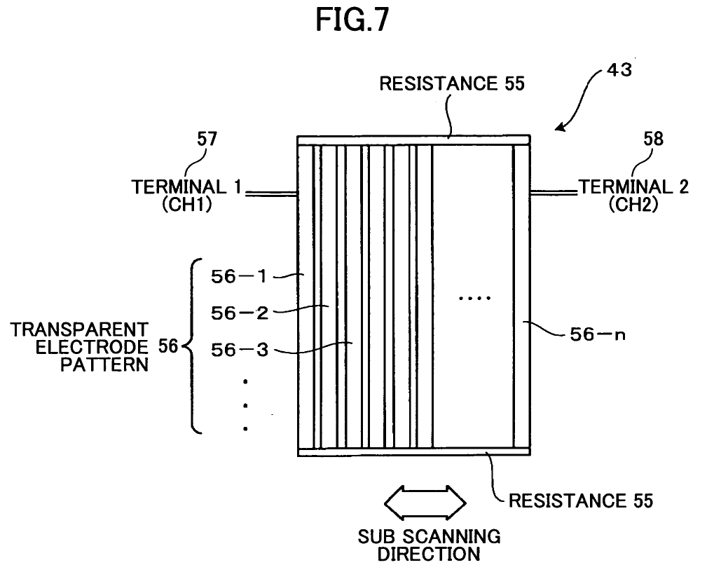

FIG. 7 illustrates details of the effective area A of the liquid crystal material 43 as viewed from the incidence side.

Shown in FIG. 7 are resistance members 55, stripe transparent electrode patterns 56, and connection terminals 57, 58 for electric connection.

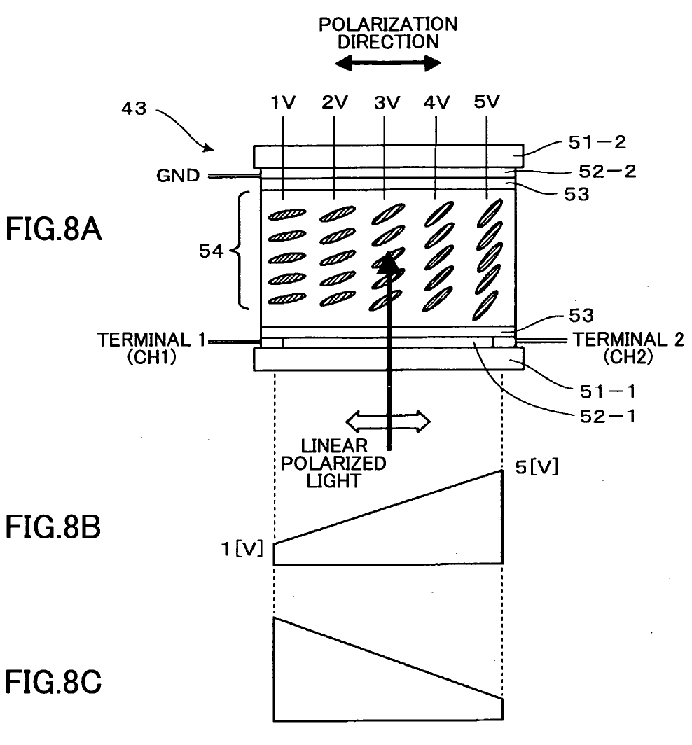

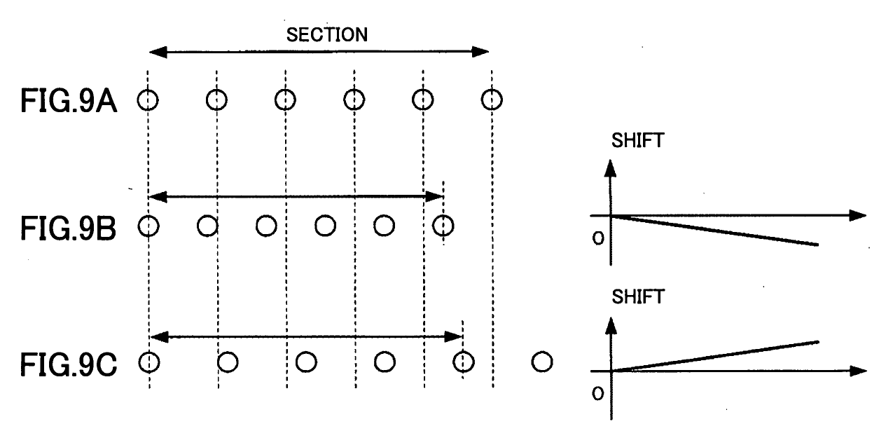

FIG. 8A through FIG. 8C illustrate the effects when a voltage is applied on the liquid crystal material 43, where FIG. 8A schematically shows alignment of liquid crystal molecules, FIG. 8B shows a distribution of the potential induced by the voltage application, and FIG. 8C shows a distribution of the refractive index of the liquid crystal material 43 corresponding to the potential distribution.

In FIG. 8A, a liquid crystal layer 54 having a thickness from a few μm to a few tens of μm is sandwiched by two glass substrate 51-1 and 51-2 via transparent electrodes 52-1, 52-2, and an alignment film 53. In FIG. 8A, the laser beam is incident from the lower side, the transparent electrode 52-2 on the upper side (exit surface side) is an integral one, and the transparent electrode 52-1 on the lower side (incidence surface side) includes stripe-like electrode patterns disposed at regular intervals, as shown in FIG. 7.

Below, referring to FIG. 7, a configuration of the transparent electrode 52-1 is described.

The transparent electrode 52-1 on the lower side (incidence surface side), as shown in FIG. 7, includes stripe-like electrode patterns 56-1, 56-2, 56-n extending in the vertical direction disposed at regular intervals in the horizontal direction, and.

The stripe-like electrode patterns 56-1, 56-2, . . . , 56-n are electrically connected by a pair of the resistance members 55 at the two ends of the stripe-like electrode patterns 56-1, 56-2, . . . , 56-n.

In FIG. 7, the horizontal direction is the direction in which the light path of the laser beam is deflected, and when correcting scanning line intervals of plural beams, the horizontal direction corresponds to the sub scanning direction.

The stripe-like electrode pattern 56-1 and the stripe-like electrode pattern 56-n, which are at the two ends of the sequence of the stripe-like electrode patterns 56, include a terminal 57 and a terminal 58, respectively, and driving signals can be applied to the terminals 57, 58. When different voltages are applied on the terminals 57, 58, a linear potential distribution is generated in the liquid crystal layer with the resistance value of the resistor 55 being a proportional constant (constant gradient). According to this potential distribution, the tilt angle of the liquid crystal molecules in the liquid crystal layer 54 can be modified. When a light beam, which is polarized in a direction of the long axis of the liquid crystal when an external voltage is not applied, is incident into thus aligned liquid crystal molecules, as shown in FIG. 8C, the refractive index of this incident light beam has a gradient in a direction of the polarization direction. Therefore, this liquid crystal element behaves like a prism, and is able to deflect an incident light beam. By changing the voltage applied on the two terminals, the gradient of the refractive index can be changed; thereby, it is possible to control the deflection angle of the light beam.

If this liquid crystal deflection element is installed between the light source unit 250 and the cylindrical lens 209, by changing the voltage applied on the two terminals, the image write positions in the sub scanning direction can be adjusted, and the color shift in the sub scanning direction can be corrected.

Furthermore, even when using a MEMS (Micro Electro Mechanical System) mirror, because the light beam can be deflected in the sub scanning direction, the color shift in the sub scanning direction can be corrected.

In the present invention, in order to correct the unevenness of beam spot position intervals in the main scanning, preferably, an effective scanning region is divided into plural sections, and the correction is performed separately in each of the sections. This is explained in the following.

When viewing the output image information first and then performing correction of the unevenness of beam spot position intervals (that is, color shift), if new color shifts occur in one place after color shifts are corrected in another place, the correction will be time-consuming. By dividing the effective scanning region into plural sections, and performing the correction separately in each of the sections, the correction can be performed independently in each of the sections, even when color shifts are corrected in one place, new color shifts do not occur in another place. As a result, the correction can be separately performed only in sections where color shifts occur, and the correction becomes very simple.

However, if correction is performed in only one section to enlarge or shrink the beam spot position intervals, the width of the section where the correction has been performed ends up being changed, and all beam spot positions from this section to the end point of the scanning change by an amount equaling the variation of the width of the section. In order to avoid this problem, it is necessary to perform a reversed correction in sections near the section where the correction has been performed to shrink or enlarge the beam spot position intervals accordingly.

Nevertheless, if it is possible to perform a correction that does not induce the variation of the section width, for example, shrinking the beam spot position intervals at the ends of a section, and enlarging the beam spot position intervals at the center of the section, it is not necessary to perform the reversed correction.

FIG. 9A through FIG. 9C are diagrams for explaining the principle of correcting beam spot position shifts in one section.

Specifically, FIG. 9A shows an ideal state, FIG. 9B shows a state in which spot intervals are narrowed, FIG. 9C shows a state in which the spot intervals are enlarged, and graphs on the right side show the shift in the horizontal direction in terms of displacements in the vertical direction.

Below, the method is explained with reference to FIG. 9A through FIG. 9C, in which the effective scanning region is divided into plural sections, and the beam spot position correction is performed separately in each of the sections, thereby correcting the unevenness of beam spot position intervals.

First, consider the case of one section. FIG. 9A shows the beam spot positions before correction. In FIG. 9A through FIG. 9C, the dotted lines are drawn at regular intervals. It is desired that the beam spot positions be on the dotted lines, but because of various reasons as described above, the beam spot positions are not on the dotted lines. Further, the state shown in FIG. 9A, in which the beam spot positions before correction are on the dotted lines, is just an ideal state; in practice, the beam spot positions before correction are not on the dotted lines. Hence, it is necessary to correct the shifts from the dotted lines.

FIG. 9B shows that the beam spot positions intervals are equally narrowed.

As shown in FIG. 9B, the width of the section, which is defined by the distance between the two beam spot positions at the ends of the section, is reduced, that is, the beam spots become more closely spaced.

FIG. 9C shows that the beam spot positions intervals are equally enlarged.

As shown in FIG. 9C, the width of the section is increased, that is, the beam spots become more distantly spaced.

The lines on the right side schematically show the position shifts from the dotted lines, where, the ordinate represents the magnitude of the shift. The position shift is positive when the beam dot is on the right side of the dotted line in FIG. 9A through FIG. 9C, and the position shift is negative when the beam dot is on the left side of the dotted line in FIG. 9A through FIG. 9C. The gradients of the lines reflects the magnitudes of shrinkage or enlargement of the beam spot positions intervals, and when the beam spot positions intervals are greatly shrunk or enlarged, the gradients of the lines increase. In practice, the actual position shifts do not follow such a straight line, but usually follow a curve such as a sine wave. Hence, in the present invention, the curved position shifts are divided into a number of sections, and in each section, the position shifts approximately form a straight line.

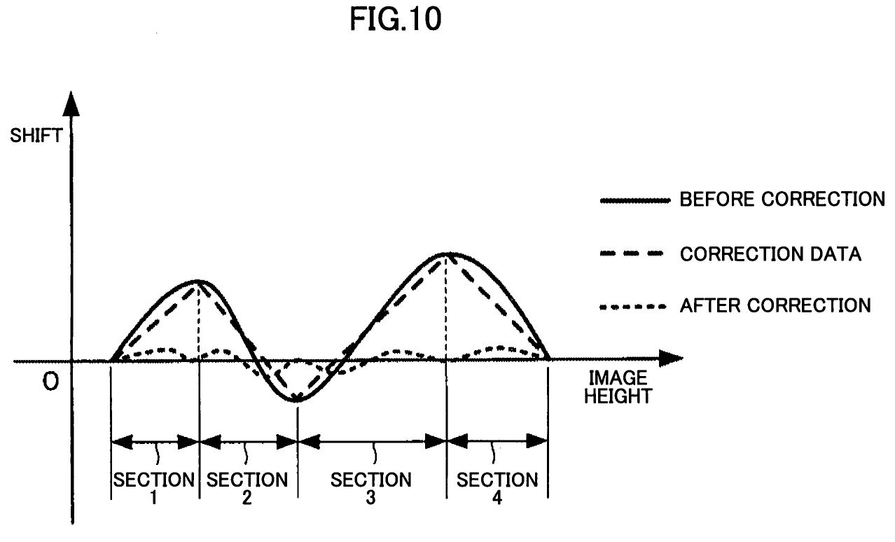

FIG. 10 shows an example of dividing one line into plural sections.

In FIG. 10, the solid line represents the position shift before correction, the dashed line represents the correction data, and the dotted line represents the position shift after correction.

The solid line is divided into a number of sections with the boundaries of sections being at the starting point and end point of the solid line, and near peaks and valleys of the solid line. In each section, as shown by the dashed line, a straight line connecting the two ends of the section is used to approximately express the actual position shifts. In each section, the difference between the solid line (actual position shifts before correction) and the dashed line (correction data) correspond to corrected position shifts.

In the example shown in FIG. 10, in section 1 and section 3, similar to FIG. 9C, the beam spots are more distantly spaced, and in section 2 and section 4, similar to FIG. 9B, the beam spots are more closely spaced.

For example, in section 1, the gradient of the solid line is positive, indicating that the position spot position intervals before correction are greater than the ideal one. In order to make the original position spot position intervals close to the ideal one, as shown in FIG. 9B, it is necessary to make correction involving a negative gradient to decrease the position spot position intervals. Such a correction is equivalent to changing the gradient of the dashed line from positive to negative, corresponding to finding the difference between the solid line and the dashed line.

In the same way, in the section 2, correction is made by using a straight line having a gradient inverse to the gradient of the illustrated straight line.

With the above method of corrections, by combining the states in FIG. 9B and FIG. 9C, and by appropriately changing the magnitudes of shrinkage or enlargement of the beam spot positions intervals, it is possible to make correction as shown by the dashed line in FIG. 10, and convert the position shift before correction, represented by the solid line, to the position shift as represented by the dotted line. In other words, according to the present invention, it is possible to correct the unevenness of beam spot position intervals at high precision.

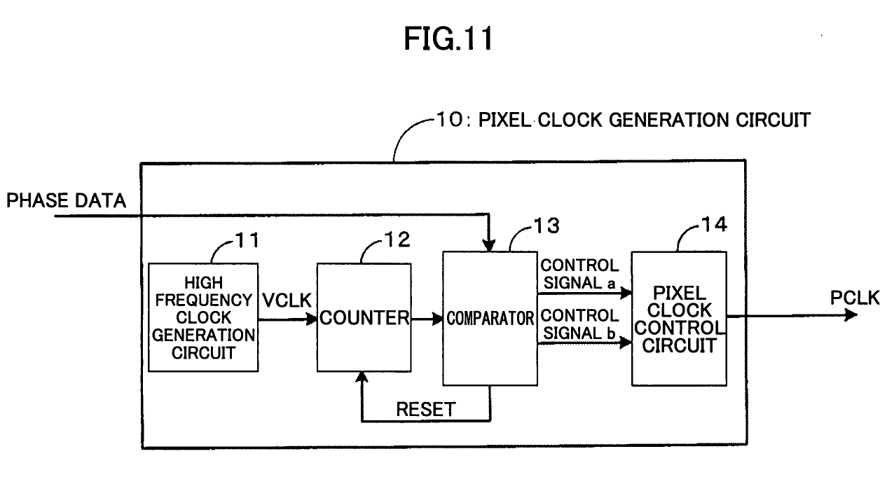

FIG. 11 is a block diagram illustrating a circuit for generating a pixel clock signal.

In FIG. 11, a pixel clock generation circuit 10 includes a high frequency clock generation circuit 11, a counter 12, a comparator 13, and a pixel clock control circuit 14.

In each section, by shifting the phase of the pixel clock signal, the timing of light emission of the light beams is adjusted, and the unevenness of beam spot position intervals can be corrected.

In FIG. 11, the high frequency clock generation circuit 11 generates a high frequency clock signal VCLK serving as a reference of a pixel clock signal PCLK. The counter 12 operates at the rising edge of the high frequency clock signal VCLK to count the high frequency clock signal VCLK. The comparator 13 compares the output of the counter 12 to a preset value and phase data input from outside which indicates a transition timing of the pixel clock, and outputs control signals “a” and “b” based on the comparison results. The pixel clock control circuit 14 controls the transition timing of the pixel clock signal PCLK based on the control signals “a” and “b”.

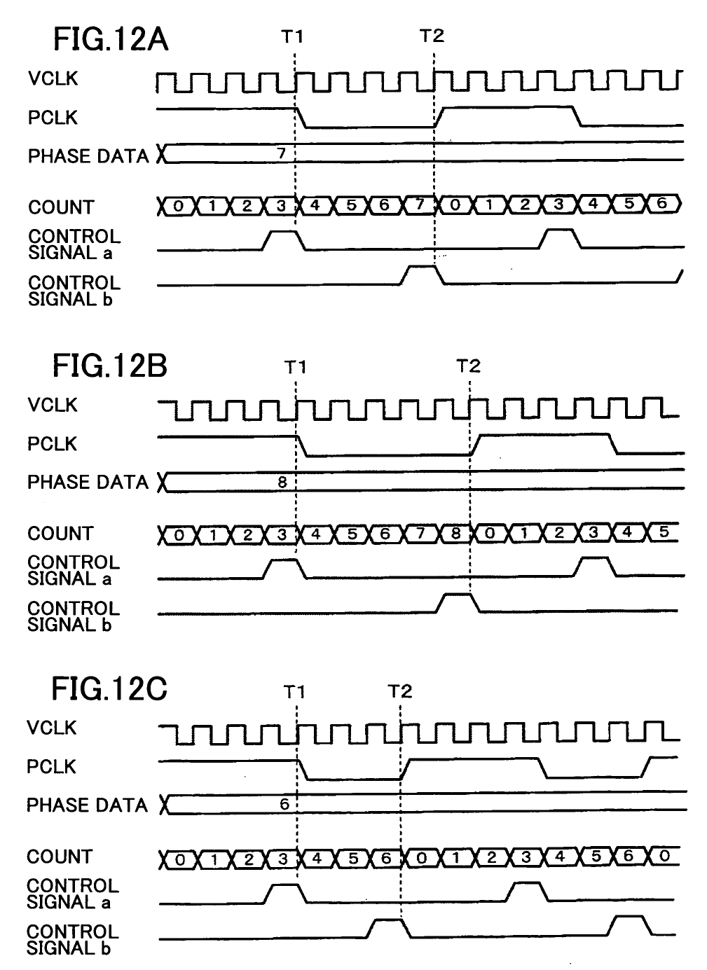

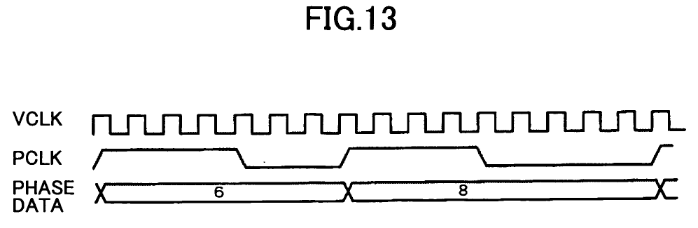

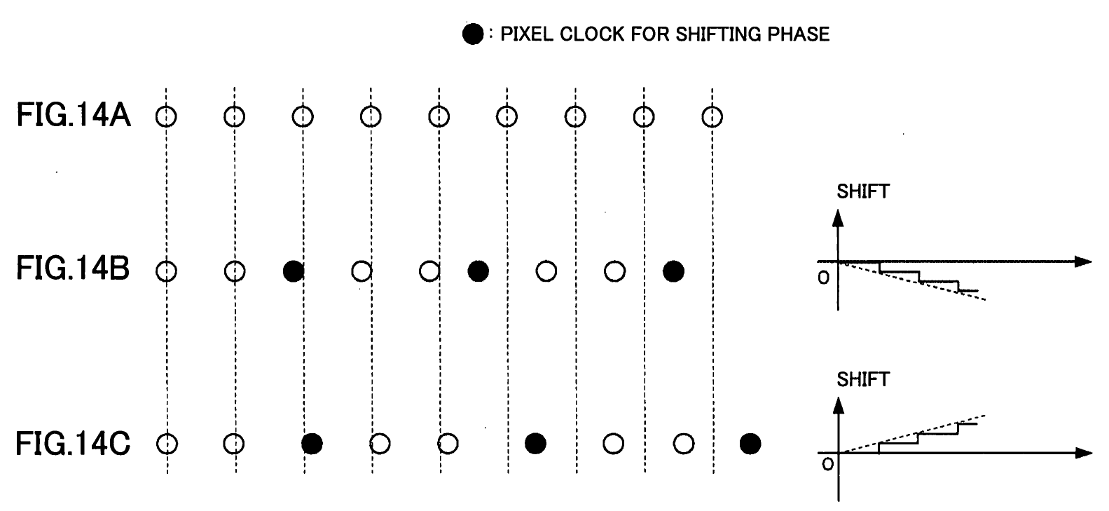

FIG. 12A through FIG. 12C are timing charts illustrating operations of the circuits shown in FIG. 11, for explaining the principle of changing the period of the pixel clock based on the phase data indicating the transition timing of the pixel clock.

Specifically, FIG. 12A shows a standard state, FIG. 12B shows a state of an advanced phase, and FIG. 12C shows a state of a delayed phase.

Here, the “phase data” are data indicating the magnitude of the phase shift of the pixel clock, which are used to correct scanning irregularity caused by characteristics of scanning lenses, to correct dot position shifts caused by rotation irregularity of the polygonal mirror, or to correct dot position shifts caused by the chromatic aberration of the laser beam. Usually, the phase data are expressed by digital data of a few bits.

Here, assume the pixel clock signal PCLK is obtained by dividing the frequency of the high frequency clock signal VCLK by eight, and has a duty ratio of 50% as a standard state.

FIG. 12A illustrates such a pixel clock signal PCLK having a frequency equaling one-eighth of the frequency of the high frequency clock signal VCLK, having a standard duty ratio of 50%.

FIG. 12B illustrates a pixel clock signal PCLK of a phase data advanced by one clock of the high frequency clock signal VCLK.

FIG. 12C illustrates a pixel clock signal PCLK of a phase data delayed by one clock of the high frequency clock signal VCLK.

As illustrated in FIG. 12A, the phase data is assigned to be “7”. A value “3” is preset in the comparator 13. The counter 12 operates at the rising edge of the high frequency clock signal VCLK to count the high frequency clock signal VCLK. The comparator 13 first outputs the control signal “a” when the count given by the counter 12 becomes “3”. The pixel clock control circuit 14 changes the pixel clock signal PCLK from a high level “H” to a low level “L” at timing T1 after the control signal “a” turns to the high level Next, the comparator 13 compares the count from the counter 12 to a given phase data, and outputs the control signal “b” when the count equals the given phase data. Specifically, in FIG. 12A, the comparator 13 outputs the control signal “b” when the count from the counter 12 becomes “7”. The pixel clock control circuit 14 changes the pixel clock signal PCLK from the low level “L” to the high level “H” at a timing T2 after the control signal “b” changes to the high level “H”. At the same time, the comparator 13 resets the counter 12 to allow the counter 12 to count from zero again.

As shown in FIG. 12A, it is possible to generate a pixel clock signal PCLK having a frequency equaling one-eighth of the frequency of the high frequency clock signal VCLK and having a standard duty ratio of 50%.

It should be noted that when the pre-setting value in the comparator 13 changes, the duty ratio changes.

As illustrated in FIG. 12B, the phase data is assigned to be “8”. The counter 12 operates at the rising edge of the high frequency clock signal VCLK to count the high frequency clock signal VCLK. The comparator 13 first outputs the control signal “a” when the count given by the counter 12 becomes “3”. The pixel clock control circuit 14 changes the pixel clock signal PCLK from the high level “H” to the low level “L” at the timing T1 after the control signal “a” turns to the high level “H”.

Next, the comparator 13 compares the count from the counter 12 to a given phase data (here, it is “8”), and outputs the control signal “b” when the count equals the given phase data. The pixel clock control circuit 14 changes the pixel clock signal PCLK from the low level “L” to the high level “H” at the timing T2 after the control signal “b” changes to the high level “H”. At the same time, the comparator 13 resets the counter 12 to allow the counter 12 to count from zero again.

As a result, as shown in FIG. 12B, it is possible to generate a pixel clock signal PCLK having a phase data advanced by one clock of the high frequency clock signal VCLK.

As illustrated in FIG. 12C, the phase data is assigned to be “6”. The counter 12 operates to count the high frequency clock signal VCLK. The comparator 13 first outputs the control signal “a” when the count given by the counter 12 becomes “3”. The pixel clock control circuit 14 changes the pixel clock signal PCLK from the high level “H” to the low level “L” at the timing T1 after the control signal “a” turns to the high level “H”.

Next, the comparator 13 compares the count from the counter 12 to a given phase data (here, it is “6”), and outputs the control signal “b” when the count equals the given phase data. The pixel clock control circuit 14 changes the pixel clock signal PCLK from the low level “L” to the high level “H” at the timing T2 after the control signal “b” changes to the high level “H”. At the same time, the comparator 13 resets the counter 12 to allow the counter 12 to count from zero again.

As a result, as shown in FIG. 12C, it is possible to generate a pixel clock signal PCLK having a phase data delayed by one clock of the high frequency clock signal VCLK.

FIG. 13 is a timing chart for explaining another example of assigning the phase data.

For example, the phase data may be assigned in synchronization with the rising edge of the pixel clock signal PCLK, hence, it is possible to change the phase of the pixel clock signal PCLK one clock by one clock.

As described above, it is possible to adjust the phase of the pixel clock signal PCLK in units of pulses of the high frequency clock signal VCLK in the positive direction and the negative direction. In other words, it is possible to correct the beam spot positions.

In addition, since it is possible to change the phase of the pixel clock signal PCLK one clock by one clock, it is possible to perform precise correction.

In addition, since it is possible to change the phase of the pixel clock signal PCLK one clock by one clock, it is necessary to store the phase data for each clock pulse, thus requiring a memory of a large capacity, and inducing increased cost.

In order to reduce the cost, the effective scanning region may be divided into plural sections, and in each section, the phase of the pixel clock signal PCLK may be shifted in a predetermined interval, and further, the number of pixels to be shifted in a phase may be changed in each section. With such a configuration, it is possible to greatly reduce the required capacity of the memory.

FIG. 14A through FIG. 14C are diagrams exemplifying phase shift of the pixel clock signal PCLK two pixels by two pixels.

By shifting the phase of the pixel clock signal PCLK each time two pixels, although the beam spot position after correction changes in a stepwise pattern, because the phase shift correction to the pixel clock signal PCLK is small (for example, 1/16 of the pixel clock signal PCLK), the change of the beam spot position after correction can be approximately regarded as a linear one, and the slope of the straight line can be changed by changing the interval of phase shift. In other words, by phase shift in a predetermined interval, it is possible to approximately perform correction as shown in FIG. 10.

From the point of view of simplifying the algorithm, it is preferable that the phase shift correction be a constant (for example, + 1/16 or − 1/16 of the pixel clock signal PCLK).

In addition, in each of the above-mentioned sections, it is not always necessary to shift the phase in a predetermined interval. According to the conditions of the beam spot position shifts, to which the correction is to be performed, the intervals of pixels, whose phases are to be shifted, may be increased or decreased, and this enables optical scanning with high precision.

It should be noted that in the present invention, the “phase data” is not limited to data indicating the phase shift correction, but also includes information indicating whether phase shift in a predetermined interval is to be performed.

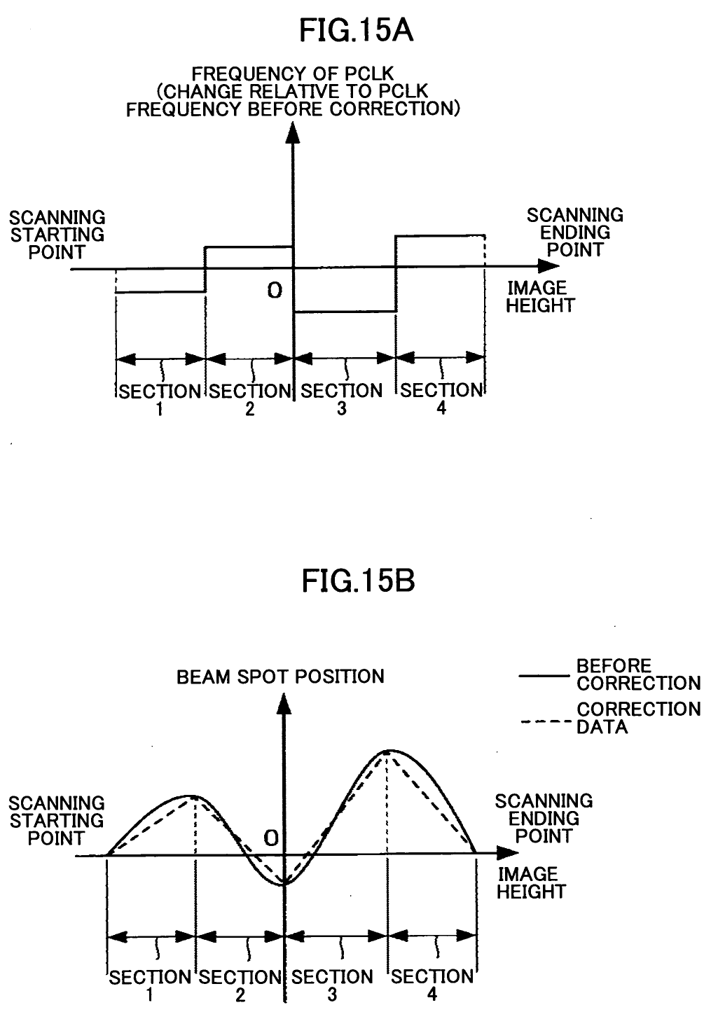

FIG. 15A and FIG. 15B explain the method of changing the frequency of the pixel clock signal PCLK in each section.

FIG. 15A shows a method of assigning the frequency of the pixel clock signal PCLK, and FIG. 15B corrected phase shift positions.

The correction to the phase shift positions may also be attained by changing the frequency of the pixel clock signal PCLK in each section.

As shown in FIG. 15A, by changing the frequency of the pixel clock signal PCLK in a stepwise manner, as shown in FIG. 15B, the phase shift positions can be corrected by using a first order function in each section.

Certainly, the change of the frequency of the pixel clock signal PCLK is not limited to the stepwise manner, but can be a first order function, or a second order function.

In the method of dividing the effective scanning region into plural sections to correct the unevenness of the beam spot position intervals, as described with reference to FIG. 10, at the boundaries of sections (division points), the functions expressing the beam spot position correction bend. Thus, in each section, values of the beam spot position correction can be determined from the values of the beam spot position correction at the division points. Due to this, it is sufficient to measure color shifts from the image information output at positions near the division points. In doing so, it becomes very easy to determine the beam spot position correction, and it is possible to make correction to the detected position shifts reliably reflecting the measured color shifts.

In order to perform color shift correction with high precision, it is necessary to measure color shifts in the output image information at as many positions as possible. However, if the color shift measurement positions are too many, when measuring the color shift by eye, it is difficult to distinguish these positions.

In addition, with color shift based only on the output image information, if the installation environment changes or an unexpected shock happens, color shifts may occur again, and in this case, one has to correct the color shifts by using the output image information. As a result, the number of times of correction using the output image information increases. This process is bothersome and usually costs paper or other resources of the image forming device.

In order to solve the above problems, for example, additionally, plural color shift detection units can be provided along the main scanning direction to detect the color shifts after development with toner, and the color shift correction can be performed automatically based on the measurement results.

Below, a description is made of the method of detecting the color shifts with the color shift detection units.

For example, the color shift detection units read a detection pattern of the toner images, which is formed on the transfer belt 105 shown in FIG. 1 to detect the color shifts in the main scanning direction. As shown in FIG. 1, for example, each of the color shift detection units includes a LED element 231 for illumination, a photo sensor 232 for receiving reflected light, and a pair of condensing lenses 233.

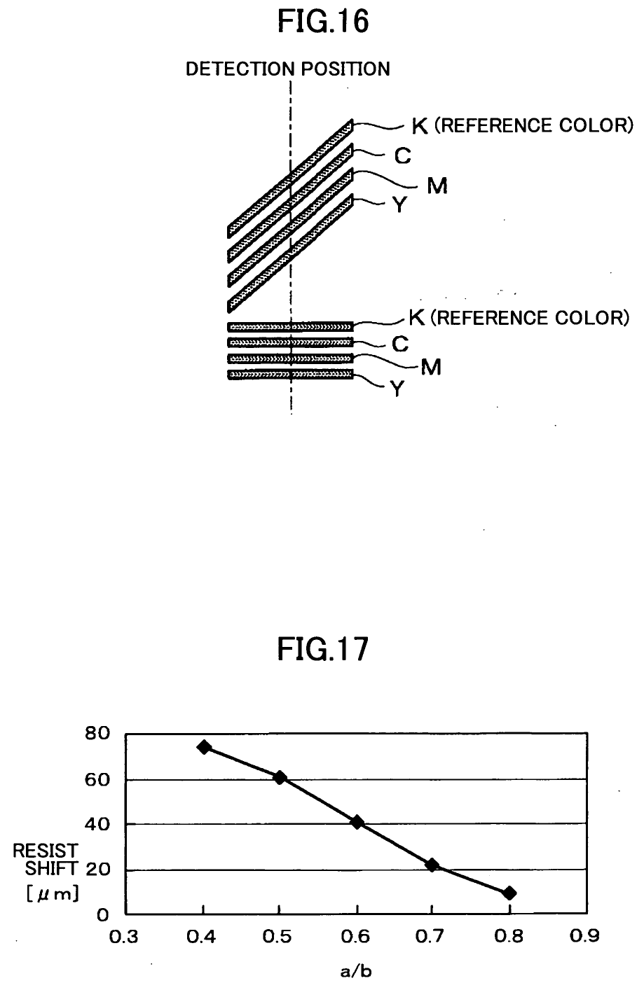

FIG. 16 is a schematic view exemplifying the detection pattern of the toner images.

As shown in FIG. 16, for example, black (K) (the reference color), cyan (C), magenta (M), and yellow (Y) toner images are arranged in a line to form a group of line patterns inclined by 45 degrees relative to the main scanning direction, and form a group of line patterns along the main scanning direction. These groups of line patterns are read out sequentially along with movement of the transfer belt 105 to detect color shift relative to the reference color black in the main scanning direction.

In principle, more color shift detection units enables higher precision of color shift correction. However, with more color shift detection units, the color shift detection and processing time of the detection data become time consuming, and the dead time due to the color shift detection units becomes longer. For this reason, it is preferable that the number of the color shift detection units be as small as possible.

Therefore, it is preferable to use the automatic color shift correction with color shift detection units and color shift correction based on the output image information together. Preferably, the number of the color shift detection units is 2 to 5.

FIG. 17 is a graph showing measurement data of resist shift, where the abscissa represents a ratio of a detection interval a to a main scanning width b.

As shown in FIG. 17, the most striking color shift in the main scanning direction is the shift of the writing position, that is, the shift of a resist. Thus, it is necessary to precisely correct the resist shift. The automatic correction with the color shift detection units is suitable for this correction because of high precision correction. In order to correct the resist shift with the color shift detection units, among all of the color shift detection units, if the interval between two color shift detection units at outermost positions (write starting position and write ending position) is a (mm), and the image formation width in the main scanning direction is b (mm), it is found that the resist shift can be corrected satisfactorily and the color shift can be corrected satisfactorily, when a and b satisfy the relation 0.6≦a/b≦1.

Table 1 shows the measurement data.

| | COLOR SHIFT | POSITION OF |
|---|---|---|
| | CORRECTION | OUTERMOST COLOR |
| | RESIDUAL | SHIFT DETECTION |
| a/b | [μm] | UNIT [mm] |
| 0.4 | 74.6 | ±60 |
| 0.5 | 60.6 | ±75 |
| 0.6 | 41.0 | ±90 |
| 0.7 | 22.0 | ±105 |
| 0.8 | 9.4 | ±120 |

In this measurement, the images are formed in a region at a center of 0 mm and extending from +150 mm to −150 mm, and the color shift detection units are also arranged around a center.

When a/b is less than 0.6, it is found that the resist shift cannot be corrected effectively, and when a/b is greater than 1.0, it is equivalent to the color shift detection units being provided outside the effective scanning region, where the optical characteristics such as the beam diameter cannot be guaranteed, and the detection error becomes large.

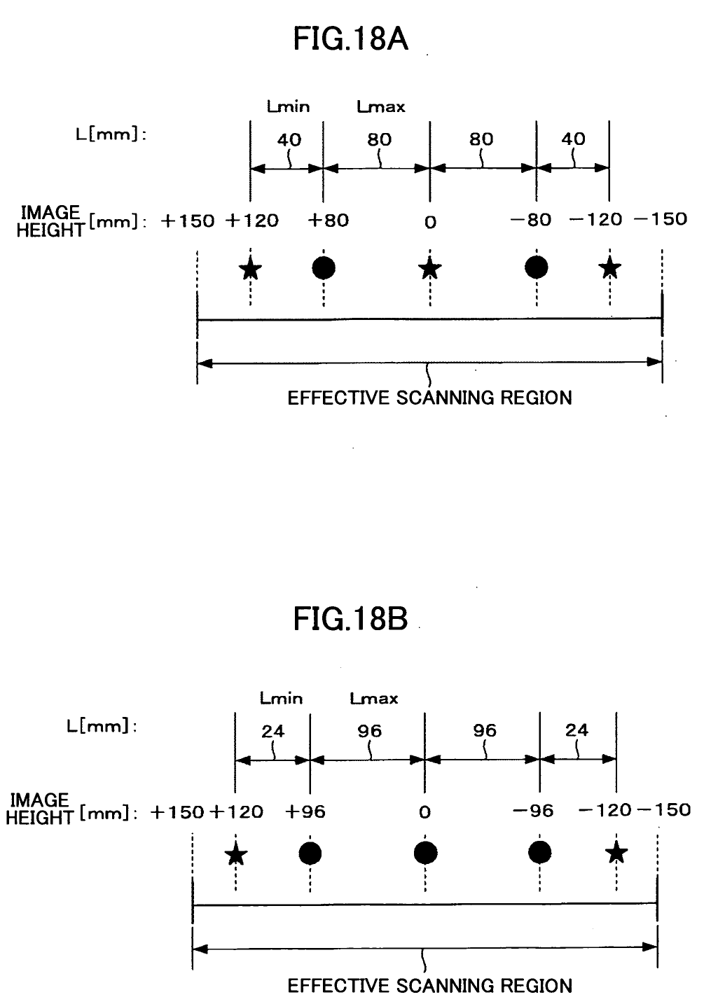

FIG. 18A and FIG. 18B are diagrams exemplifying positions of color shift detection based on image information and positions of the color shift detection units.

In FIG. 18A and FIG. 18B, black stars indicate the positions of the color shift detection units, and black circles indicate the positions of color shift detection based on image information.

In FIG. 18A and FIG. 18B, the positions of color shift detection based on image information are on the inner side of the color shift detection units at the outermost positions (write starting position and write ending position) among all the color shift detection units (black stars); in addition, the detection position of the position shift and positions of the position shift detection units are arranged so that the following formula is satisfied:
L max/L min<3

where L max represents the largest one of widths L of sections separated by the position shift detection positions and the positions of the position shift detection units, and L min represents the smallest one of the widths L of the sections. The positions of color shift detection based on image information and the positions of the position shift detection units are arranged so that the above formula can be satisfied.

Table 2 shows the measurement data.

| | COLOR SHIFT | POSITION OF | COLOR SHIFT |
|---|---|---|---|
| | CORRECTION | COLOR SHIFT | DETECTION |
| Lmax/ | RESIDUAL | DETECTION UNIT | POSITION WITH |
| Lmin | [μm] | [mm] | IMAGE [mm] |
| 1 | 60.3 | ±120.0 | ±60 |
| 2 | 78.8 | ±120.0 | ±80 |
| 3 | 85.8 | ±120.0 | ±90 |
| 4 | 93.0 | ±120.0 | ±96 |
| 5 | 108.5 | ±120.0 | ±100 |

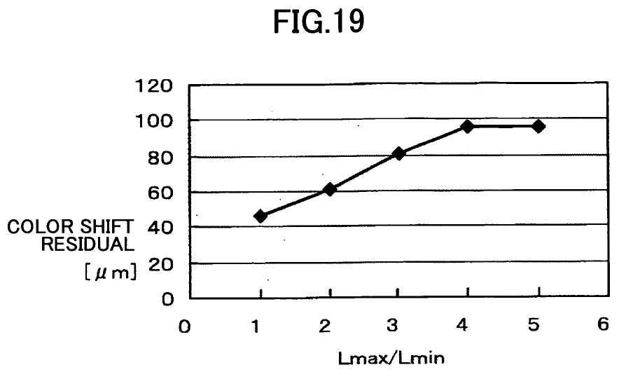

FIG. 19 is a graph showing measurement data under different arrangements.

Similar to the example in FIG. 17, in this measurement, the images are formed in a region at a center of 0 mm and extending from +150 mm to −150 mm. It is preferable that the positions of color shift detection based on image information and the positions of the color shift detection units be arranged so that L max/L min is as close as possible to 1, but as long as L max/L min is less than 3, it is possible to correct the color shift to such an extent that the color shift cannot be perceived by a person's eyes.

As for the order of the color shift correction based on the output image information and the color shift correction by using the color shift detection units, for example, first, the color shift may be automatically corrected based on detection results of the color shift detection units, and after that, the image information is output to perform the color shift correction. In addition, because the maximum color shift occurs usually in the middle of two color shift detection units, it is effective to measure the color shift from the image information in the middle of color shift detection units to perform the color shift correction.

However, depending on the installation environment and methods of usage, the maximum color shift occurs at different positions. Due to this, the color shift may be measured from the output image information to make the color shift correction position selectable. In doing so, it is possible to improve the color shift correction precision.

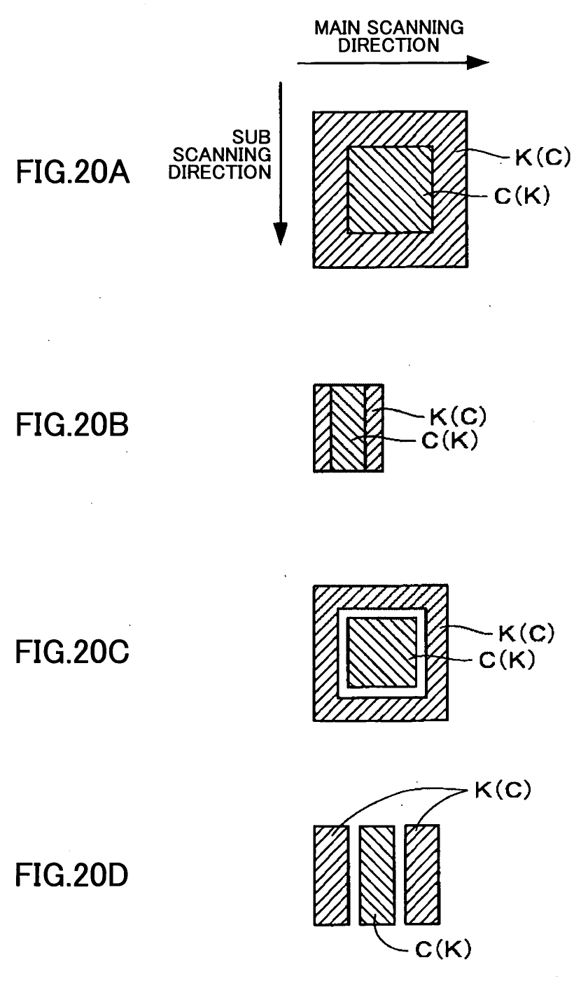

FIG. 20A through FIG. 20D are diagrams illustrating patterns suitable for detecting the color shift by using the output images.

Specifically, FIG. 20A and FIG. 20C show patterns able to detect the color shifts in not only the main scanning direction but also the sub scanning direction; FIG. 20B and FIG. 20D show patterns able to detect the color shifts only in the main scanning direction.

In FIG. 20A through FIG. 20D, a symbol K represents the reference color, a symbol C represents the color to be corrected (below, simply refer to as “correction color”). The parentheses with the symbols C or K therein indicate that the reference color and the correction color can be switched.

As shown in FIG. 20A through FIG. 20D, the graphic (pattern unit) enabling color shifts to be most recognizable by a human's eyes include an image of the reference color arranged around an image of the color to be measured. FIG. 20A shows a preferable pattern, in which an image of the reference color is arranged around an image of the color to be measured in both the main scanning direction and the sub scanning direction. In the pattern shown in FIG. 20B, images of the reference color are arranged beside the image of the color to be measured at least in the main scanning direction.

It is described here that an image of the reference color is arranged around an image of the color to be measured; certainly, the same effect can be obtained with an image of the color to be measured being around an image of the reference color.

As shown in FIG. 20C and FIG. 20D, there is a small gap between the image of the reference color and the image of the color to be measured. In doing so, the color shift can be more recognizable. For example, the gap is symmetric in the horizontal direction and in the vertical direction. For example, the width of the gap is two or a few multiples of an interval of two dots distinguishable by the resolution of the image forming device. If the width of the gap is too large, it becomes difficult to recognize the magnitude of the shift.

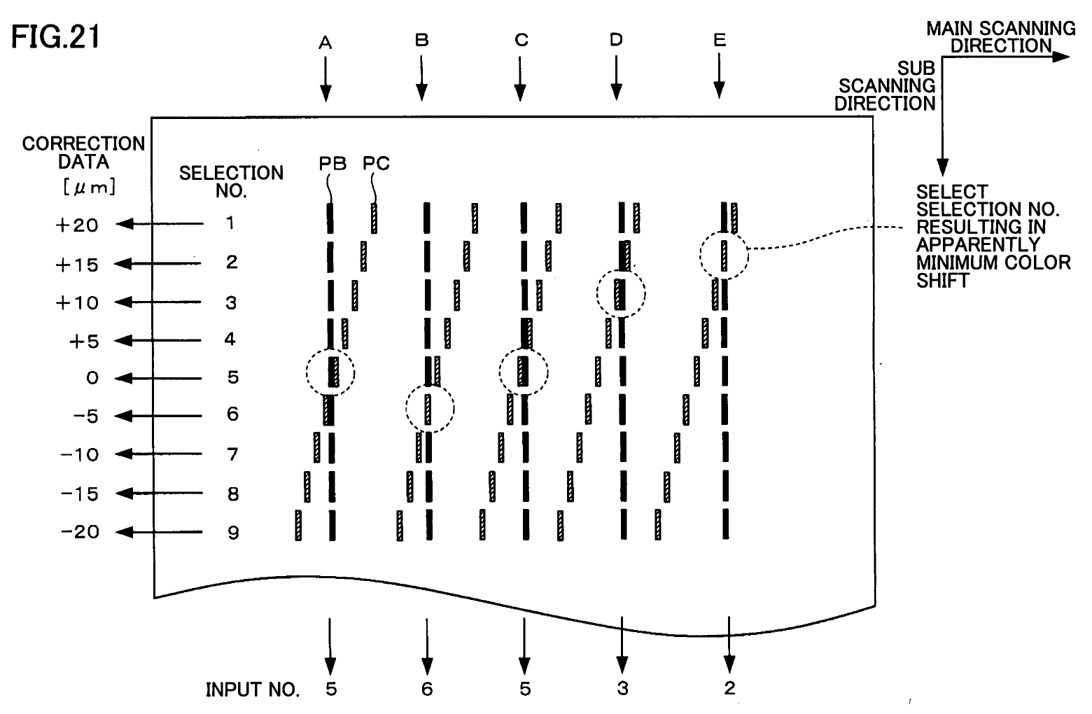

FIG. 21 is a diagram illustrating an example of output of a pattern for detecting the color shifts in the main scanning direction.

In FIG. 21, a symbol PB represents a black pattern of the reference color, and a symbol PC represents a cyan pattern of the correction color.

The color shift can be detected with the output color shift detection pattern, and when correcting the color shift, for example, one may output the color shift detection pattern as shown in FIG. 21.

Below, the output color shift detection pattern is explained. Here, assume the correction color is cyan. Further, assume there are five measurement positions A, B, C, D, and E. In FIG. 21, for convenience, it is illustrated that the intervals between the measurement positions A, B, C, D, and E are equal, but it should be noted that the intervals between the measurement positions A, B, C, D, and E are not necessarily equal.

Usually the intervals between the measurement positions A, B, C, D, and E are a few tens of millimeters, and the shift of the color shift detection pattern is at most 0.1 mm. For purpose of illustration, in FIG. 21, the shift of the color shift detection pattern is enlarged.

The detection patterns PB of the reference color are set to be nearly at the center of the detection positions. For example, the pixel clock is counted, and when a preset count is reached, it is deemed that the object measurement position is arrived at. Because the measurement positions A, B, C, D, and E are not necessarily at regular intervals, it is necessary to store the preset count in a memory corresponding to respective target measurement positions.

The detection patterns PC of the correction color are arranged in a line in the sub scanning direction with the write start positions of the detection patterns PC being shifted in stepwise manner and are output. For example, the write start positions of the detection patterns PC are shifted relative to the detection position in units of 5 μm, with the maximum shift being ±20 μm, thus totally 9 stages of the detection patterns PC are output stage by stage with the position shift being from 0 μm to ±20 μm. Even though the write start position of the first detection pattern is shifted, the intervals between the detection patterns PC are set to be equal to the intervals between the detection patterns PB in terms of the pulse number of the pixel clock signal. The position intervals between the detection patterns PB of the reference color are not varied. Here, a combination of the detection patterns PB and PC starting to write at the same position in the sub scanning position is called “a pattern line”.

When outputting the detection pattern, the corresponding position shifts (or numbers assigned to the position shifts) are also output. Checking the color shift detection patterns PB, a position shift with least color shift can be found, and this position shift is used as shift correction data. In FIG. 21, instead of position shifts, the shift correction data are illustrated.

If the images formed by the image forming device does not include distortion at all, no mater where the detection position is, the detection patterns PB of the reference color and the detection patterns PC of the correction color ought to be overlapped at the shift correction data of 0 (of a selection number 5). However, since local stretch and shrinkage of the patterns may occur in the main scanning direction, the position where the detection patterns PB and PC overlap changes along with the detection positions. When correcting color images, the correction to color shift (shift of a relative position relative to the reference color) is more important than correction to an absolute position.

At each detection position, the shift correction data resulting in least color shift can be used as shift correction data at the corresponding detection position. With the correction data are selected and input corresponding to the detection position, the color shift can be corrected.

Below, the procedure of determining correction data from an output image is described.

For example, at the detection position A, the position where the detection patterns PB of the reference color and the cyan detection patterns PC are closest to each other corresponds to correction data of 0 μm (selection No. 5). In other words, it is determined that color shift does not occur near the detection position A.

At the detection position B, the position, where the detection patterns PB of the reference color and the cyan detection patterns PC are closest to each other corresponds to correction data of −5 μm (selection No. 6). In other words, it is determined that cyan color should be shifted to the right by 5 μm at the detection position B.

With the above color shift detection patterns, it is possible to easily and precisely detect the color shift, and simplify input operation of the correction data.

In FIG. 21, it is shown that the correction data or the corresponding selection number is output together with the color shift detection patterns, but this is not required.

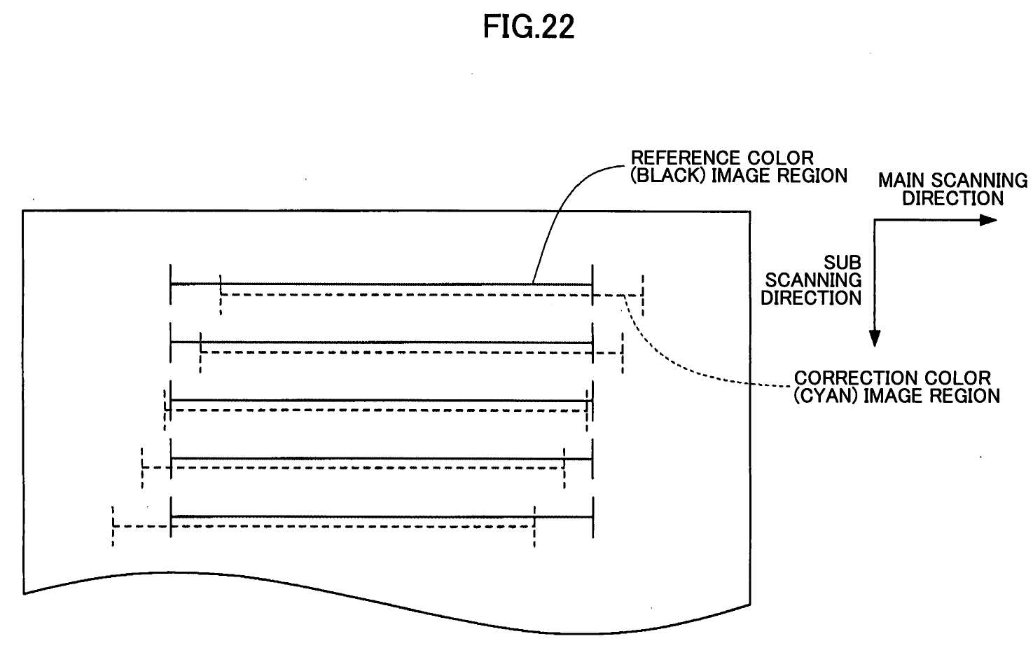

FIG. 22 is a diagram illustrating a method of shifting the detection pattern in the sub scanning direction.

Specifically, FIG. 22 shows a method of shifting the write start position in the main scanning.

Similarly, in FIG. 22, it is assumed that the black color is the reference color, and the cyan color is the correction color.

To shift the write start position of the first pattern, for example, the write start position of the image of the correction color can be shifted only in the main scanning direction without changing the correction state of the unevenness of intervals of positions of beam spots in the effective scanning region, and the image area can be shifted in the main scanning direction. In this way, shifting the write start position of the first pattern can be realized very easily.

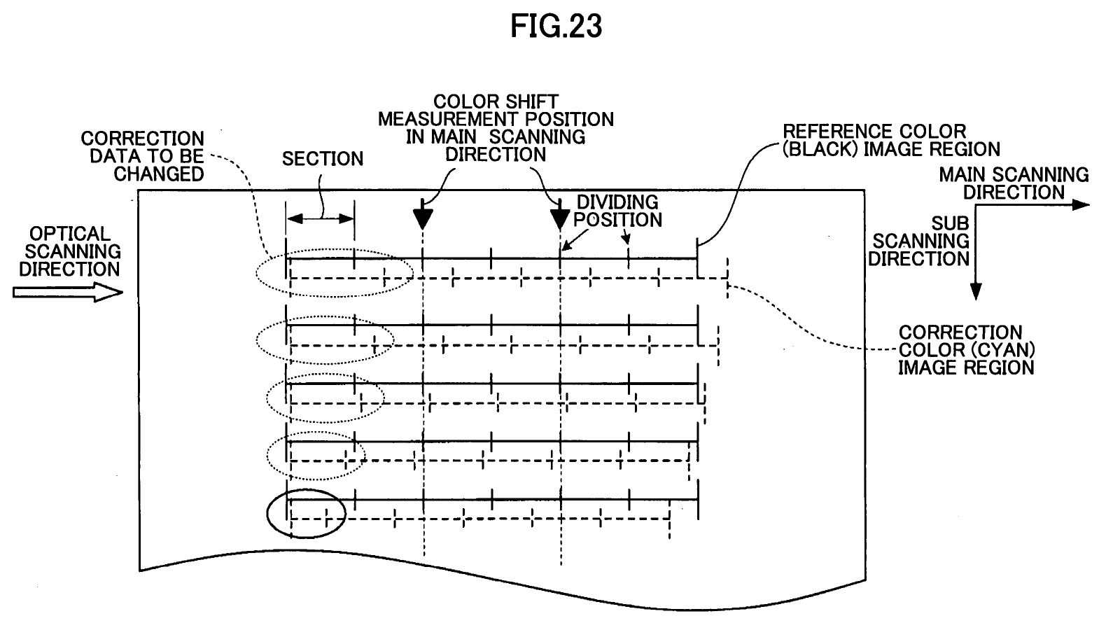

FIG. 23 is a diagram illustrating a method of shifting the detection pattern in the sub scanning direction.

Specifically, FIG. 23 shows a method in which the write start positions are the same but the pixel number after writing is changed.

Similarly, in FIG. 23, it is assumed that the black color is the reference color, and the cyan color is the correction color.

As shown in FIG. 23, in order to change the position of the patterns in a stepwise manner, for example, the effective scanning region is divided into plural sections, and the number of pixels and the beam spot position correction data are changed in at least one section out of these sections on the scanning start side (but not at a position in the main scanning direction to measure the color shift). In this way, changing the pattern position stepwise can be achieved.

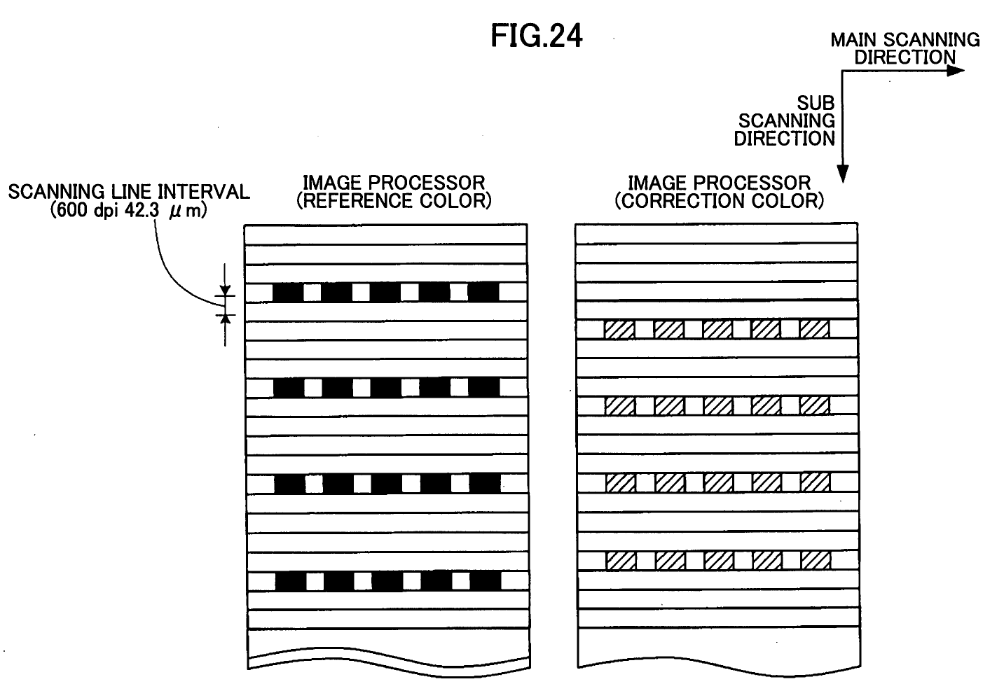

FIG. 24 is a diagram illustrating an example of output of a pattern for detecting the color shifts in the sub scanning direction.

Specifically, FIG. 24 shows arrangement (for example, location in a memory) of images ought to be output.

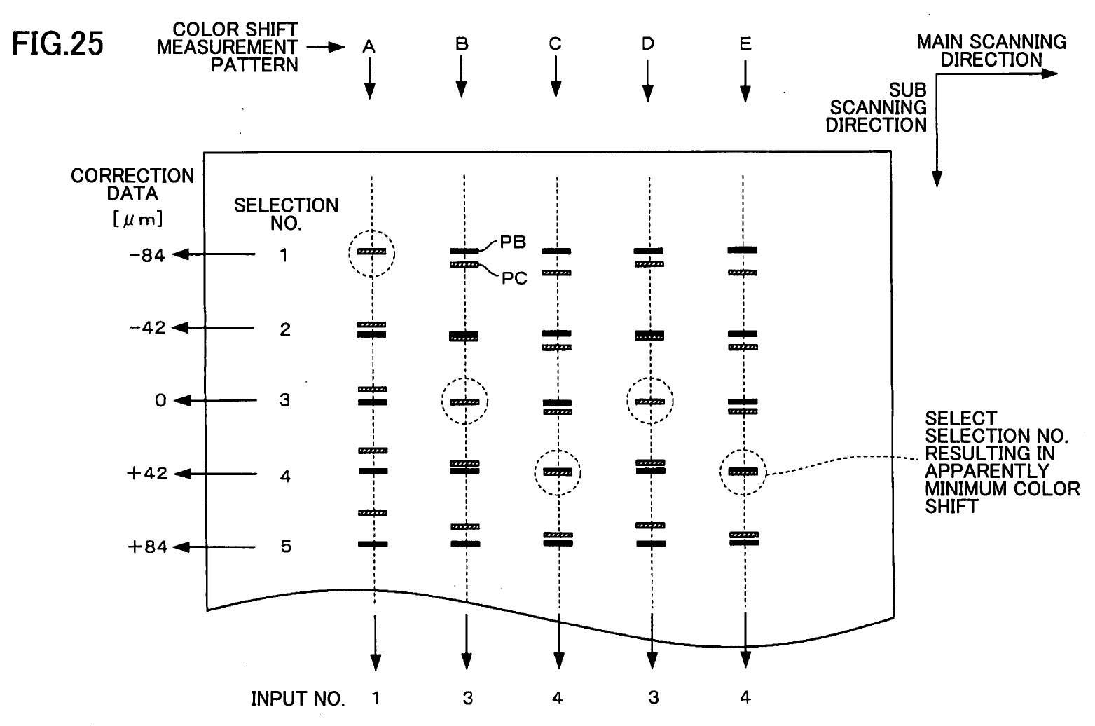

FIG. 25 is a diagram illustrating an example of output of a pattern for detecting the color shifts in the sub scanning direction. Specifically, FIG. 25 shows output on a medium.

Similarly, in FIG. 24 and FIG. 25, it is assumed that the black color is the reference color, and the cyan color is the correction color, and the same symbols are assigned to the same elements as those described above.

In order to find the color shift in the sub scanning direction, the detection patterns PB of the reference color are arranged at measurement positions A, B, C, D, and E on the main scanning line to form a pattern line of the detection patterns PB, and at least three pattern lines of the detection patterns PB are formed in the sub scanning direction at predetermined intervals. It should be noted that although it is preferable that the intervals between the pattern lines be equal, it is not required.

Similarly, the detection patterns PC of the color to be measured (simply refer to as “measurement color” where necessary) are arranged at the measurement positions A, B, C, D, and E on the same main scanning line to form a pattern line of the detection patterns PC, and at least three pattern lines of the detection patterns PC are formed in the sub scanning direction at the same predetermined intervals.

It should be noted that the detection patterns PB and the detection patterns PC may be set to overlap with each other completely. However, with the detection patterns PB and the detection patterns PC overlapping each other completely, it becomes difficult to determine the pattern shift. Thus, it is preferable to relatively set the detection patterns PB and the detection patterns PC.

In the example shown in FIG. 25, the interval between two scanning lines in the sub scanning direction is 42 μm. Five pattern lines of the detection patterns PC are formed, which are shifted by 0 μm, ±42 μm, ±84 μm relative to the pattern lines of the detection patterns PB. Note that in FIG. 24, the last pattern line is omitted.

The number of the pattern lines may be either even or odd, although usually it is though that it is relatively easy to handle an odd number of the pattern lines. When the number of the pattern lines is odd, the pattern line of the detection patterns PB of the reference color at the center and the pattern line of the detection patterns PC of the measurement color at the center can be arranged at the same position in the sub scanning direction with a position shift equaling 0.

When the number of the pattern lines is even, one or two pattern lines of the detection patterns PB near the center and one or two pattern lines of the detection patterns PC near the center can be arranged at the same positions in the sub scanning direction with a position shift equaling 0.

In FIG. 24, intervals between the pattern lines of the detection patterns PC are set to be smaller than intervals between the pattern lines of the detection patterns PB. But the same effect as above can be obtained even when the intervals between the pattern lines of the detection patterns PC are set to be larger than the intervals between the pattern lines of the detection patterns PB. Namely, it is sufficient as long as one of the intervals is larger than the other intervals.

If relative bending of the scanning lines caused by color does not occur, the detection patterns PC and the detection patterns PB ought to be relatively at regular intervals in the sub scanning direction. In addition, if the shift does not occur in the sub scanning direction, the detection patterns PC and the detection patterns PB included in the pattern line, in which the shift between the detection patterns PC and the detection patterns PB is zero, ought to be in agreement at all of the measurement positions A, B, C, D, and E. In practice, since a slight relative shift occurs, this shift is detected for correction.

Concerning determination using images, in addition to differences of the main scanning and the sub scanning, the descriptions of shift in the main scanning direction in the above are the same. In the example shown in FIG. 24, from the measurement positions A, B, C, D, and E, selection numbers 1, 3, 4, 3, 4 are obtained sequentially.

With the above measurements, it is possible to determine the bending of the scanning lines of the measurement color relative to the reference color.

The method of correcting the bending of the scanning lines can be applied to the prism and liquid crystal elements as described above if the response speed matches. Namely, in the above example, it is described to adjust the write start position in the main scanning direction with a high precision equivalent to less than one scanning line in each adjustment in the sub scanning direction. With the above method of scanning line bending correction, by performing control when writing on main scanning line, it is possible to achieve correction corresponding to the measurement results.

In practice, the purpose of correction is not to correct the relative scanning line bending in one pattern line, but to find a state in which the overall overlapping of the pattern line of the measurement color is strong relative to the pattern line of the reference color. For example, the average of the five selection numbers may be calculated, and by using this average number, the write start position in the sub scanning direction of the measurement color in the overall image can be fine adjusted. Even when the average is not an integer, it is possible to make adjustment below one line.

When exchanging the optical scanning unit, usually, the optical scanning characteristics of the optical scanning units before and after exchanging are not correlated to each other at all. That is, even when correction data for unevenness of the beam spot position intervals optimized in the optical scanning unit before exchanging is applied to the optical scanning unit after exchanging, there is no correction effect at all. In other words, it is necessary to perform corrections by using the method as described so far to obtain correction data for the unevenness of the beam spot position intervals suitable for the optical scanning unit after exchanging.

In the optical scanning unit after exchanging, in order to appropriately correct the correction data of the unevenness of the beam spot position intervals, for example, the correction data of the unevenness of the beam spot position intervals for the new optical scanning unit can be attached, and it is sufficient to just input the attached correction data after the new optical scanning unit is exchanged.

As for the method of inputting the attached correction data, for example, SD cards or other storage media can be used, or the correction data can be input from an operational panel or input from a personal computer via a network. In doing so, color shift can be corrected satisfactorily.

Note that here, by “exchange”, it means to exchange the whole optical scanning unit, or exchange parts of the optical scanning unit at the site of the image forming device; in addition, it also means to exchange parts of the optical scanning unit at the site of the image forming device by users or service persons, or transport the whole image forming device to the factory for exchanging.

However, even after the correction data of the unevenness of the beam spot position intervals for the new optical scanning unit are input, when the installation environment changes or unexpected shock to the image forming device occurs, color shift cannot be corrected appropriately; thus, non-negligible color shift may occur again. In this case, the above mentioned color shift detection units arranged in the main scanning direction can be used to detect the color shift and to correct the color shift automatically.

Depending on the installation environment and the installation conditions, even after the correction data of the unevenness of the beam spot position intervals of the new optical scanning unit are input, and even after the above mentioned color shift detection units are used to detect the color shift and to correct the color shift automatically, non-negligible color shift may still persist. In this case, as described above, color shift correction can be made with the output image information.

When being used for CAD, it is necessary to reduce the distortion of images as much as possible. For this purpose, it is necessary to set the beam spot position intervals to be equal, and absolute position precision of the beam spot positions is required.

In the above, although the descriptions are made with the multi-color image forming device as an example, by replacing “color shift correction” with “correction of absolute positions of beam spot positions”, the present invention is also applicable to a black-white image forming device.

Thus, with the present invention, it is possible to correct the absolute positions of the beam spot positions, and to provide image of high quality free from distortion.

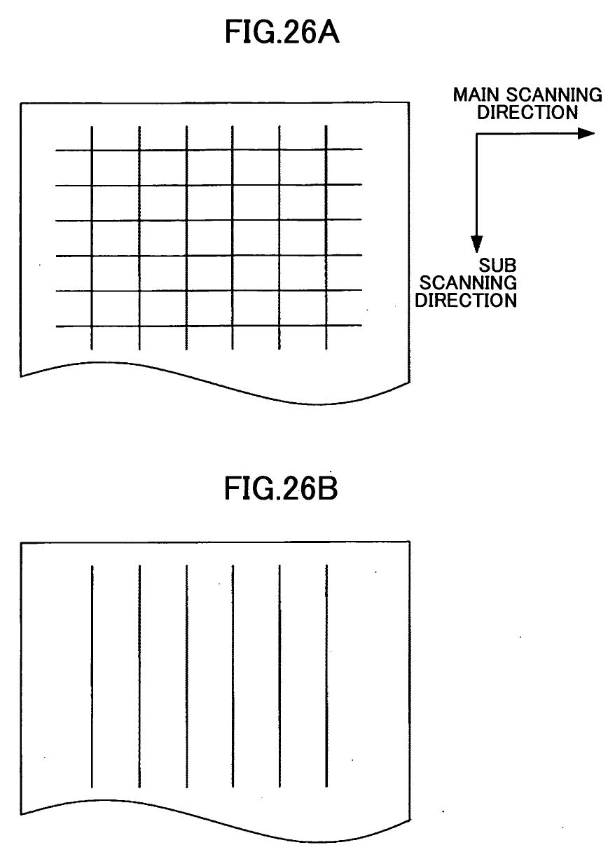

FIG. 26A and FIG. 26B are diagrams illustrating examples of media on which predetermined patterns are printed in advance.

Specifically, FIG. 26A shows a grating-like pattern, and FIG. 26B shows a pattern of vertical lines.

Although the present invention is described with multi-color images as an example, the present invention is not limited to this, but can be applied to monochromatic images, and furthermore, can be broadly applied to detect and correct beam spot position shifts. In this case, the reference for recognize the position shift is set on an absolute position on a medium.

Specifically, in order to correct the absolute positions of the beam spot positions, it is necessary to output to the medium on which a reference position is provided. Here, “the medium on which a reference position is provided”, as shown in FIG. 26A, may be paper or other media on which a grating-like pattern is printed in advance, or as shown in FIG. 26B, may be paper or other media on which a pattern of vertical lines, which are parallel to the sub scanning direction and are arranged in the main scanning direction, is printed in advance, or any other media on which graphics (lines, characters, and so on) are printed in advance to provide at least a reference in the main scanning direction.

With either of the above patterns, it is preferable to arrange the vertical lines near measurement positions, because this reduces uncertainties of decision.

After measurements, the above-mentioned correction methods using the measurement results for multi-color images can be used directly.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Applications No. 2004-372233 filed on Dec. 22, 2004, the entire contents of which are hereby incorporated by reference.

What is claimed is:

1. An image forming device, comprising:
a light source;
an optical scanning unit configured to scan a light beam from the light source on an image supporting member to form an electrostatic latent image thereon, said optical scanning unit being exchangeable;
a development unit configured to develop the electrostatic latent image with toner to form a visible image;
a transfer unit configured to transfer the visible image to a medium;
a test image output unit configured to output a test image able to determine unevenness of intervals of positions of beam spots formed on the image supporting member;
a beam spot position correction unit configured to correct the unevenness of the beam spot position intervals; and
a correction data input unit configured to select correction data of the unevenness of the beam spot position intervals.

2. The image forming device as claimed in claim 1, further comprising:
a plurality of position shift detection units that are arranged along a main scanning direction to detect shifts of the beam spot positions;
wherein the unevenness of the beam spot position intervals is corrected based on detection results of the position shift detection units.

3. The image forming device as claimed in claim 2, wherein the test image includes a test pattern for measuring a position shift at least in the main scanning direction of the beam spot.

4. The image forming device as claimed in claim 3, wherein the test pattern has a shape enabling measurement of position shifts in both the main scanning direction and a sub scanning direction.

5. The image forming device as claimed in claim 4, further comprising:
an insertion unit configured to insert a blank line in front of the first line of image data of an ordinary image;
a deletion unit configured to delete the blank line; and
an addition unit configured to add a blank line;
wherein
an image forming position in the sub scanning direction is changed each time by one scanning line by using the insertion unit, the deletion unit, and the addition unit.

6. The image forming device as claimed in claim 4, further comprising:
a counting unit configured to count a write starting signal in the main scanning direction;
wherein
an image forming position in the sub scanning direction is changed each time by one scanning line by reducing the count from the counting unit.

7. The image forming device as claimed in claim 4, further comprising:
a deflection unit configured to deflect the light beam in the sub scanning direction;
wherein
an image forming position in the sub scanning direction is changed by using the deflection unit.

8. The image forming device as claimed in claim 7, wherein the deflection unit is a turnable prism.

9. The image forming device as claimed in claim 7, wherein the deflection unit is a liquid crystal element able to deflect the light beam electronically.

10. The image forming device as claimed in claim 2, wherein measurement positions of the position shift of the beam spot are selectable.

11. The image forming device as claimed in claim 2, wherein the beam spot position correction unit performs beam spot position correction by shifting a phase of a pixel clock signal.

12. The image forming device as claimed in claim 2, wherein the beam spot position correction unit divides a scanning region into a plurality of sections, and performs the beam spot position correction in each of the sections.

13. The image forming device as claimed in claim 12, wherein the position shift detection units are provided near boundary positions between the sections, and the position shift of the beam spot is corrected based on the detection results of the position shift detection units.

14. The image forming device as claimed in claim 2, wherein assuming a distance between two of the position shift detection units at outermost positions is a mm, and an interval between two test images is b mm in the sub scanning direction, a and b satisfy the following formula:
0.6≦a/b≦1.

15. The image forming device as claimed in claim 2, wherein
a position of measuring the position shift based on image information is arranged on an inner side of one of the position shift detection units at the outermost position; and
the position of measuring the position shift and positions of the position shift detection units are arranged so that the following formula is satisfied:
L max/L min<3
where L max represents the largest one of widths L of sections separated by positions of the position shift detection units, and L min represents the smallest one of the widths L of the sections.

16. The image forming device as claimed in claim 2, wherein
the image forming device is a multi-color image forming device; and
the position shift detection units are color-shift detection units.

17. The image forming device as claimed in claim 16, wherein
the test image includes a plurality of unit patterns each having a first pattern of a reference color and a second pattern of a color of a measurement object, and one of the first pattern and the second pattern is arranged on two sides of another one of the first pattern and the second pattern in the main scanning direction.

18. The image forming device as claimed in claim 16, wherein
the test image includes a plurality of lines of patterns;
each of the pattern lines includes a plurality of first patterns each of a reference color and a plurality of second patterns each of a color of a measurement object, a number of said first patterns being equal to a number of said second patterns, said first patterns and said second patterns being arranged in the main scanning direction;
in each of the pattern lines, intervals between the first patterns are equal to the intervals between the second patterns; and
in different pattern lines, positions of the second patterns relative to the first patterns change stepwise in the main scanning direction.

19. The image forming device as claimed in claim 18, wherein
when setting the relative positions of the second patterns relative to the first patterns to change stepwise in the main scanning direction, an optical scanning starting position of a color to be corrected is set to change stepwise.

20. The image forming device as claimed in claim 18, wherein
when setting the positions of the second patterns relative to the first patterns to change stepwise in the main scanning direction,
a number of pixels on a scanning starting side relative to a position of measuring the position shift is increased or decreased, or correction data of the beam spot positions is increased or decreased.

21. The image forming device as claimed in claim 16, wherein
the test image includes three or more lines of patterns each including a plurality of the first patterns arranged in the main scanning direction, and three or more lines of patterns each including a plurality of the second patterns arranged in the main scanning direction, said second patterns being arranged to be at substantially the same positions as said first patterns;
the lines of the first patterns are arranged to be at first predetermined intervals in the sub scanning direction; and
the lines of the second patterns are arranged to be at second predetermined intervals in the sub scanning direction;
a number of the lines of the first patterns is the same as a number of the lines of the second patterns.

22. The image forming device as claimed in claim 21, wherein
a line of patterns near a center of the three or more lines of the first patterns is at a position the same as a line of patterns near a center of the three or more lines of the second patterns in the sub scanning direction; and
intervals between the three or more lines of the first patterns and intervals between the three or more lines of the second patterns are different by a value equaling a width of one line in the sub scanning direction.

23. An image forming method used by an image forming device, said image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals,
said method comprising a step of:
obtaining the correction data from the test image and inputting the correction data by the correction data input unit.

24. An image forming method used by a multi-color image forming device, said multi-color image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, a correction data input unit configured to select correction data of the unevenness of the beam spot position intervals, and a plurality of color shift detection units that are arranged along a main scanning direction to detect color shifts,
said method comprising a step of:
outputting, after the color shift is corrected based on detection results of the color shift detection units, the test image to correct a color shift between two of the color shift detection units and a color shift at a position outside two ends of the color shift detection units.

25. An image forming method used by an image forming device, said image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals,
said method comprising a step of:
inputting the correction data at least when exchanging the optical scanning unit.

26. An image forming method used by an image forming device, said image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals,
said method comprising the steps of:
preparing respective correction data for different optical scanning units to correct the unevenness of the beam spot position intervals of main scanning associated with optical scanning properties of respective optical scanning units; and
inputting the correction data when exchanging the optical scanning unit.

27. The image forming method as claimed in claim 25, wherein
while inputting the correction data at least when exchanging the optical scanning unit, detecting position shifts by a plurality of the position shift detection units to correct the position shifts.

28. An image forming method used by an image forming device, said image forming device including a light source, an optical scanning unit configured to scan a light beam from the light source on an image supporting member to form an electrostatic latent image thereon, said optical scanning unit being exchangeable, a development unit configured to develop the electrostatic latent image with toner to form a visible image, a transfer unit configured to transfer the visible image to a medium, a test image output unit configured to output a test image able to determine unevenness of intervals of positions of beam spots formed on the image supporting member, a beam spot position correction unit configured to correct the unevenness of the beam spot position intervals, and a correction data input unit configured to select correction data of the unevenness of the beam spot position intervals,
said method comprising a step of:
outputting the test image to a medium in which a reference of an absolute position in the main scanning direction is recorded.
